(19) United States
(12) Patent Application Publication
(10) Pub. No.: US 2021/0292554 A1
(43) Pub. Date: Sep. 23, 2021

(54) MODIFIED POLYAMIDE FIBER AND ARTICLES MADE THEREOF

(71) Applicant: INVISTA North America S.A.R.L., Wilmington (DE)

(72) Inventors: Alexander Gulledge, Columbia, SC (US); Jacob Lockhart, Wilmington, DE (US); Milind V. Kantak, Wilmington, DE (US); Anand Viswanath, Columbia, SC (US); Joshua J. Wahrmund, Chattanooga, TN (US)

(21) Appl. No.: 17/260,836

(22) PCT Filed: Jul. 17, 2019
(86) PCT No.: PCT/US2019/042101

§ 371 Date: Jan. 15, 2021

Related U.S. Application Data
(60) Provisional application No. 62/699,978, filed on Jul. 18, 2018.
(60) Provisional application No. 62/808,322, filed on Feb. 21, 2019.

(51) Int. Cl. C08L 77/06; C08L 77/02; D01F 6/90; D01F 1/10; D01F 6/60; D01F 6/30

(52) U.S. Cl. CPC C08L 77/06; C08L 77/02; D01F 6/90; D01F 1/10; D01F 6/60; D10B 2401/021; C08L 2203/12; C08L 2205/025; C08L 2205/035; C08L 2207/53; D10B 2503/04; D01F 6/30

(57) ABSTRACT

Disclosed are fibers comprising a modified polyamide, such as a modified nylon-6, a modified nylon-6,6, or a modified nylon-5,6. The polyamide may be modified to contain a modified polyolefin, such as a maleated polyolefin. The disclosed fibers are hydrophobic and have surprising properties and benefits as compared to fibers having the same base polymer but without modification.

### PRIORITY CLAIM

This application is a national stage entry of international PCT Application No. PCT/US2019/042101 filed on Jul. 17, 2019, which claims priority to U.S. Provisional Application Nos. 62/699,978, filed on Jul. 18, 2018 and 62/808,322, filed on Feb. 21, 2019, the entireties of which are herein incorporated by reference.

### FIELD

The disclosure relates to polymer fibers and articles made thereof. Disclosed fibers may be modified to impart hydrophobicity into the fiber. The disclosed modification may provide a surprisingly soft fiber without compromising durability, and may also enhance water-repellency and drying time, compared to unmodified fibers of similar base polymer.

### BACKGROUND

Synthetic fibers make up the bulk of fibers used in carpets. Synthetic fibers are also used in numerous other articles, including textiles and other articles made with woven, non-woven, and knit fibers. Polyamide fibers, such as nylon-6 and nylon-6,6, are popular due to their resiliency, wear-resistance, ability to accept dyes, and cleanability. There are, however, areas for improvement with existing nylon fibers. For example, nylon fibers are attracted to acid dyes, are not as inherently soft as other fibers, and still suffer from soiling and cleanability issues. Due to their amide groups, polyamide fibers are hydrophilic, leading to absorption of liquid stains spilled onto the surface of the nylon fibers. Additionally, during heat treatments, referred to as heatsetting, polyamide fibers shrink. Some solutions to these above problems have been proposed.

Generally, it is known in the carpet industry to use fluorine containing chemicals and compositions to impart a variety of valuable properties to textile fibers of synthetic or natural origin, especially to protect carpets and other textile floor coverings from wetting and soiling. U.S. Pat. Nos. 6,824,854 and 4,264,484 propose such fluorine containing chemical treatments. It has also been known to impart fluorine-free water repellency to textiles and fabrics, as disclosed in U.S. Pat. No. 10,072,378.

Topical treatments for fibers and carpets have been developed to provide fibers, fabrics and carpets with softer hand without compromising durability, reduced wicking of stains, liquid repellency performance and other benefits of commercial importance. However, any topical (or surface) treatment may not be long lasting in its benefits.

U.S. Pat. No. 6,132,839 relates to a carpet yarn having the desirable properties of nylon-6 but less heatset shrinkage than nylon-6. In the Examples of the '839 patent, the tensile properties, as well as tufting and dyeing performance of the alloy are similar to those of the control yarn. Finished tufted carpet produced from the alloy yarn reportedly performed satisfactorily in simulated and on-the-floor wear trials.

US Pub. No. 2015/0361615 relates to manufacturing a knitted, tufted, woven or non-woven fabric or film using an olefin yarn or fiber that has been enhanced to accept dye at atmospheric pressures.

International Pub. No. WO2012/024268A1 relates to a thermoplastic pelletizable polymer composition comprising: (a) a polyamide; and (b) a polymer polymerized from maleic anhydride and an olefin; wherein the polyamide and the polymer are compounded.

U.S. Pat. No. 9,353,262 discloses compositions comprising polyamides with such olefin-maleic anhydride polymers (OMAP).

Additionally, polyamide fibers may comprise diamine and diacid moieties. These moieties especially those providing substantially aliphatic groups between repeating amide linkages, are known to undergo thermal degradation during melt processing. Continued thermal degradation of nylon-6,6 is known to produce an insoluble residue called gel. Gel formation is problematic for several reasons, including buildup on equipment, reduction in the rate of melting, and a product fiber with uneven or lower than desired denier. Time and temperature above the melt range of nylon-6,6 are a critical gel forming dynamic. Finding a means to reduce gel formation in nylon-6,6 via an easily implemented additive to the polymer is a problem of long standing. It would also be desirable to provide a durable solution for polyamide fibers (including nylon fibers such as nylon-6 and nylon-6,6 fibers), fabrics and carpets with benefits including softer hand without impacting wear performance, improved ease of cleaning, reduced wicking, and reduced gel formation.

The present disclosure provides an effective and economical solution to these problems.

### SUMMARY

In some embodiments, the present disclosure is directed to a yarn comprising a fiber. In some embodiments, the present disclosure is directed to a carpet comprising a fiber. In some embodiments, the present disclosure is directed to a fiber comprising: a first continuous polymer phase; and a second polymer phase at least partially immiscible with the first continuous polymer phase and distributed in the first continuous polymer phase; wherein the second polymer phase comprises a modified polyolefin copolymer having a Melt Flow Index as measured by ASTM D1238 (190° C./2.16 kg) from 0.25 g/10 min to 20.0 g/10 min, and wherein an article made from the fiber has an ALR rating from 0 to 3 in the absence of any additional externally applied treatment to enhance the ALR rating. The first continuous polymer phase may comprise at least one of a polyamide, a polyester, and combinations thereof. The polyamide may be the reaction product of an aliphatic diacid and an aliphatic diamine. The polyamide may comprise nylon-6, nylon-6,6, nylon-5,6, a partially aromatic polyamide, an aromatic polyamide, and combinations thereof. The modified polyolefin copolymer may be maleated. The maleated polyolefin copolymer may have a degree of maleation from 0.05 to 1.5 wt. % of the polyolefin copolymer, preferably from 0.1 to 1.4 wt. %, more preferably from 0.15 to 1.25 wt. %. The polyolefin copolymer may be selected from the group consisting of polyolefin, polyacrylate, and combinations thereof. In some aspects, the polyolefin copolymer is an ionomer. In some aspects, the polyolefin copolymer has a core-shell structure. In some aspects, the polyamide comprises nylon-6, and the polyolefin copolymer is present at from 0.1 wt. % to 10 wt. %, preferably from 0.2 to 9 wt .%, more preferably from 0.25 to 8.5 wt. %; or the polyamide comprises nylon-6,6, and the polyolefin copolymer is present at from 0.1 wt. % to 7 wt. %, preferably from 0.25 to 6.5 wt. %, more preferably from 0.3 to 6 wt. %. The hydrophobicity as measured by water contact angle may be from 95° to 120°, preferably from 100° to 115°. The modified polyolefin copolymer may have a Melt Flow Index as measured by ASTM D1238 (190° C./2.16 kg) from 0.5 to 15.0 g/10 min, preferably from 1.0 to 12.0 g/10 min. The second polymer phase may be distributed in the first continuous polymer phase in domains as measured by Scanning Electron Microscopy ranging from 5 to 500 nm in cross sectional diameter, preferably from 9 to 400 nm, and from 50 nm to 6000 nm in longitudinal length, preferably from 100 to 5000 nm. The fiber may comprise from 0.1 to 10 weight % of the modified polyolefin copolymer, preferably from 0.2 to 9 wt. %, more preferably from 0.25 to 8.5 wt. %. of which up to 8 wt. % includes at least one polar functional group; and from 90 to 99.9 weight % of the polyamide. The fiber may have a dpf of 40 or less, preferably 35 or less, more preferably 30 or less. The modified polyolefin copolymer may be a reaction product formed in the presence of the first continuous polymer phase. The flame resistance performance may not be decreased as compared to a fiber consisting of the first continuous polymer phase in the absence of the second polymer phase. In some aspects, the second polymer phase is discontinuous. In other aspects, the second polymer phase is continuous. When continuous, the continuous second polymer phase may be present as an interpenetrating network.

In some embodiments, the present disclosure is directed to a yarn comprising a fiber. In some embodiments, the present disclosure is directed to a carpet comprising a fiber. In some embodiments, the present disclosure is directed to a fiber comprising a) a first continuous polymer phase; and b) a second polymer phase at least partially immiscible with the first continuous polymer phase and distributed in the first continuous polymer phase; wherein the fiber comprises from 1 ppm to 300 ppm by weight reacted polyamide-polyolefin copolymer, based on the total weight of fiber, and wherein an article made from the fiber has an ALR rating of at least 0 in the absence of any additional externally applied treatment to enhance the ALR rating. The fiber may comprise from 5 ppm to 250 ppm by weight reacted polyamide-polyolefin copolymer, based on the total weight of the fiber. The first continuous polymer phase may comprise nylon-6, nylon-6,6, nylon-5,6, a partially aromatic polyamide, an aromatic polyamide, or combinations thereof. The second polymer phase may comprise a polymer having a Melt Flow Index as measured by ASTM D1238 (190° C./2.16 kg) from 0.25 to 20.0 g/10 min The fiber may have a water contact angle from 90° to 130°, preferably from 95° to 125°.

In some embodiments, the present disclosure is directed to a composition comprising a first polyamide continuous phase and a second modified polyolefin copolymer discontinuous phase, wherein the combination exhibits reduced polymer-to-metal adhesion when the composition is in the melt or when the composition is in the form of a fiber as compared to a composition without the second modified polyolefin copolymer discontinuous phase. The fiber may be used in a yarn or carpet.

In some embodiments, the present disclosure is directed to a method for reducing the gelation rate of a condensation polyamide comprising adding to the condensation polyamide from 0.1 to 10 wt. % of a maleated polyolefin copolymer, wherein the degree of maleation in the polyolefin copolymer is from 0.05 to 1.5. The condensation polyamide may comprise nylon-6,6, nylon-6, nylon-5,6, a partially aromatic polyamide, an aromatic polyamide, or combinations thereof.

In some embodiments, the present disclosure is directed to a hydrophobic carpet comprising a polyamide, and comprising maleated polyolefin copolymer, wherein the carpet ALR value is at least 0, and wherein when the polyamide is nylon-6, the Steam Heatset Shrinkage is greater than 20%. The degree of maleation of the maleated polyolefin copolymer may be from 0.1 to 1.5 wt. %, and the polyolefin copolymer is present at from 0.2 wt .% to 9 wt. %, based on the total weight of the carpet. The carpet may meet at least one of the following conditions as compared to a carpet without the maleated polyolefin: a) equal or improved durability when measured according to the Vetterman 5/10/15K Drum testing ASTM D5417-05, b) improved water repellency preservation after Hot Water Extraction [HWE] conditions, c) suppressed liquid spill absorption on surface, d) reduced drying time, e) suppressed staining and sub-surface stain penetration, f) improved odor resistance, g) equivalent flammability performance, and/or h) improved softness. The boil off water shrinkage of the carpet may be unchanged. In some aspects, when polyamide is a polyamide other than nylon-6, the Steam Heatset Shrinkage is less than 20%.

In further embodiments, the present disclosure is directed to fibers comprising: a first continuous polymer phase; and a second polymer phase distributed in the first continuous polymer phase, wherein the second polymer phase comprises polymer having a Melt Flow Index as measured by ASTM D1238 (190° C./2.16 kg) from 0.25 g/10 min to 20.0 g/10 min, and wherein the fibers are characterized by hydrophobicity as measured by water contact angle from 90° to 130°; and wherein the second polymer phase is distributed in the first continuous polymer phase in domains as measured by Scanning Electron Microscopy ranging from 5 to 500 nm in cross sectional diameter, preferably from 9 to 400 nm, and from 50 nm to 6000 nm in longitudinal length, preferably from 100 to 5000 nm. The first continuous polymer phase of the disclosed fibers can comprise at least one selected from polyamides and polyesters. Examples of suitable polyamides include nylon-6 and nylon-6,6. The fiber can be hydrophobic. Hydrophobicity of the fiber can be characterized by water contact angle is >95° and <120°, for example, >100° and <115°. The second polymer phase can be continuous or discontinuous. If continuous, the second polymer phase can be an interpenetrating network. From a cross-sectional view, if discontinuous, the second polymer can have the appearance of islands of the second polymer in a sea of first continuous phase polymer. From a cut view in the longitudinal direction of the fiber, the second polymer phase can be nanofibrils or nanocylinders, dispersed either discontinuously or continuously, in the first polymer phase. For a description of island-in-the-sea bicomponent fibers, see Journal of Engineered Fibers and Fabrics http://wwwjeffjournal.org Volume 2, Issue 4-2007. The second polymer phase can comprise polymer having a Melt Flow Index as measured by ASTM D1238 (190° C./2.16 kg) from >0.5 g/10 min to <15.0 g/10 min, for example, from >1.0 g/10 min to <12.0 g/10 min. The second polymer phase can be distributed in the first continuous polymer phase in domains as measured by Scanning Electron Microscopy ranging from 5 to 500 nm in cross sectional diameter, preferably from 9 to 400 nm, and from 50 nm to 6000 nm in longitudinal length, preferably from 100 to 5000 nm. The disclosed fibers can comprise 0.1 to 10 weight % of a polyolefin copolymer, of which up to 8 wt. % of the polyolefin copolymer includes at least one polar functional group; and 90 to 99.9 weight % of a thermoplastic polyamide polymer. Suitable polyolefin copolymers can be selected from the group consisting of polyolefins and polyacrylates. The polyolefin copolymer can be an ionomer. The polyolefin copolymer can have a core-shell structure. In some nonlimiting embodiments, the polyolefin copolymer can comprise at least one monomer unit selected from ethylene, propylene, and butylene; and the degree of maleation of the polyolefin copolymer can be >0.01 and <10% by weight, for example, from 0.02 to 8 wt. % of the fiber, for example, from 0.1 to 1.2 wt. % of the fiber, for example, from 0.1 to 0.5 wt. % of the fiber. Surprisingly, the maleated polyolefin copolymer can be added at lower levels that previously believed effective to accomplish the desired results. The second polymer phase can comprise polyolefin copolymer having at least one polar functional group, wherein the polyolefin copolymer having at least one polar functional group is a reaction product formed in the presence of the first continuous polymer phase. The disclosed fibers can exhibit flame retardancy performance that is not decreased compared to a fiber consisting of the first continuous polymer phase in the absence of the second polymer phase. Additionally, the disclosed fibers can exhibit improved durability, stain and/or soil resistance compared to a fiber consisting of the first continuous polymer phase in the absence of the second polymer phase. The polyolefin copolymer can be maleated. If maleated, suitable degrees of maleation can range from >0.01% by weight to <1.2% by weight of the olefin copolymer.

In some embodiments, the present disclosure is directed to fiber comprising a) a first continuous polymer phase; and b) a second polymer phase at least partially immiscible with the first continuous polymer phase and distributed in the first continuous polymer phase, wherein the fiber comprises from 1 ppm to 200 ppm maleic anhydride units, based on the total weight of fiber, and wherein an article made from the fiber has an ALR rating of at least 0 in the absence of any additional externally applied treatment to enhance the ALR rating in the ALR test as described herein. The term “ALR” means Aqueous Liquid Repellency Performance Testing. As described in detail in the Examples section, an adapted procedure from the AATCC 193-2007 method is used for aqueous liquid repellency (ALR) testing. The disclosed fiber can comprise from 1 to 300 ppm reacted polyamide-polyolefin copolymer. The first continuous polymer phase can comprise a polyamide. The second polymer phase can comprise polymer having a Melt Flow Index as measured by ASTM D1238 (190° C./2.16 kg) from 0.25 g/10 min to 20.0 g/10 min. The disclosed fibers can have a dpf of from >1 to <40, for example, from >2 to <35, or for example, from >2 to <30.

### BRIEF DESCRIPTION OF THE DRAWINGS

FIG. 1 is a representation of the measured DSC curves for samples according to the present disclosure. The X-axis is temperature in degrees Celsius and the Y-axis is heat flow in mWatts [or mW].

FIGS. 2 [A-D] are representations of SEM data according to the embodiments of the present disclosure.

FIG. 3 is a visual representation of the time-evolved wicking performance data for embodiments according to the present disclosure.

FIGS. 4 [A-D] is a visual representation of the resistance to staining data for embodiments according to the present disclosure.

FIG. 5 is a representation of the Load [in Newtons] versus Elongation [in mm] data for embodiments according to the present disclosure.

FIGS. 6 [A and B] are representations of compression test data for embodiments according to the present disclosure.

FIGS. 7 [A-C] are representations of time-evolved repellency performance data for embodiments according to the present disclosure, and specifically, for Examples 11(e) and 11(h) of Table 6.

FIG. 8 is a representation of repellency performance data for embodiments according to the present disclosure, and specifically, for Examples 11(n) and 11(q) of Table 6.

FIGS. 9 [A-B] are representations of SEM data according to the embodiments of the present disclosure, and specifically, for Example 11(h) of Table 6.

FIGS. 10 [A-E] are representations of the measured SEM images for round, solid cross-section shaped Monofilament fibers of Nylon-5,6 and according to the embodiments of Examples 14(a-e) and Table 13.

### DETAILED DESCRIPTION

### Introduction

Embodiments of the invention described and claimed herein are not to be limited in scope by the specific embodiments herein disclosed, since these embodiments are intended as illustration of several aspects of the disclosure. Any equivalent embodiments are intended to be within the scope of this disclosure. Indeed, various modifications of the embodiments in addition to those shown and described herein will become apparent to those skilled in the art from the foregoing description. Such modifications are also intended to fall within the scope of the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

In the methods described herein, the steps may be carried out in any order without departing from the principles of the invention, except when a temporal or operational sequence is explicitly recited. Furthermore, specified steps may be carried out concurrently unless explicit claim language recites that they be carried out separately. For example, a claimed step of doing X and a claimed step of doing Y may be conducted simultaneously within a single operation, and the resulting process will fall within the literal scope of the claimed process.

The term “solvent” as used herein means a liquid medium that is generally regarded by one ordinarily skilled in the art as having the potential to be capable of solubilizing simple organic and/or inorganic substances.

The terms “nylon-6” or “nylon-6” or “N6” or “PA6” or “polyamide 6”, are interchangeability used to describe a semi-crystalline polyamide that is made from a ring-opening polymerization of caprolactam. It is also referred to as polycaprolactam.

The terms “nylon-6,6” or “nylon-6,6” or “nylon-6/6” or “nylon-6,6” or “N6,6” or “polyamide 66” or “PA66”, are interchangeability used to describe a polyamide that is made from a condensation polymerization of two monomers each containing 6 carbon atoms, hexamethylenediamine [HIVID or HMDA] and adipic acid [AA]. It is also referred to as poly-hexamethylene adipamide.

The term “fiber” refers to filamentous material that may be used in fabric and yarn as well as textile fabrication. One or more fibers may be used to produce a fabric or yarn. The yarn may be fully drawn or textured according to the methods known in the art. In an embodiment, the face fibers may include bulked continuous filament (BCF) for tufted or woven fabric/article/carpets.

The term “carpet” may refer to a structure including face fiber and a backing. A primary backing may have a yarn tufted through the primary backing. The underside of the primary backing may include one or more layers of material (e.g., coating layer, a secondary backing, and the like) to cover the backstitches of the yarn. In general, a tufted carpet includes a pile yarn, a primary backing, a lock coat, and a secondary backing. In general, a woven carpet includes a pile yarn, a warp, and weft skeleton onto which the pile yarn is woven, and a backing. Embodiments of the carpet may include woven, non-wovens, and needle felts. A needle felt may include a backing with fibers attached to a non-woven sheet. A non-woven covering may include backing and a face side of different or similar materials.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g., 1 to 6.1, and ending with a maximum value of 10 or less, e.g., greater than or equal to 5.5 to less than or equal to 10.

All publications, including non-patent literature (e.g., scientific journal articles), patent application publications, and patents mentioned in this specification are incorporated by reference as if each were specifically and individually indicated to be incorporated by reference.

It is understood that the descriptions herein are intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” “third,” and the like are used merely as labels, and are not intended to impose numerical requirements on their objects.

The term “wicking” as used herein means a liquid transfer across a fiber or article made thereof.

As described herein, without limiting the scope of the disclosure with a recitation of a theoretical mechanism, the generalized chemical reaction schematically represented below is one approach to understand the interaction of a maleated olefin copolymer with a polyamide.

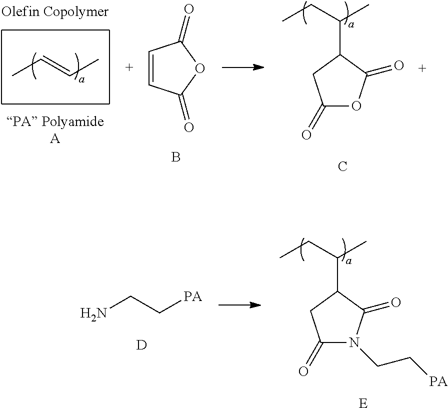

The term “PA”, as used herein, means a polyamide (structure D). Polyamide is a type of synthetic polymer made by the linkage of an amino group of one molecule and a carboxylic acid group of another. Polyamides are also generically referred to as nylons.

For the chemistry disclosed herein and throughout this disclosure; the olefin copolymer (structure A) may be any copolymer of ethylene, propylene, or butylene. The olefin copolymer may contain a suitable degree of maleation, e.g., maleic content, for example, between 0.2 to 1.2% by weight. This material is henceforth defined as “modified polyolefin” (structure C).

The term “reacted Polyamide-Polyolefin copolymer” or “modified polyamide” (structure E), as used herein is the reacted portion of the polyolefin and the polyamide matrix. This is dependent upon the original maleation content of the polyolefin additive (structure C).

The term “degree of maleation” or “modification level”, as used interchangeably herein, means the extent of which the olefin copolymer (structure A) has been reacted with maleic anhydride (structure B).

Maleic anhydride functionality may be added to the polyamide as a part of the polyolefin or may be added separately.

### Polymer Fiber

The present disclosure is directed to polymer fibers. Although some polymer fibers, such as polyamide fibers, are generally hydrophilic, the inventors have surprisingly and unexpectedly discovered methods for preparing fibers that are hydrophobic. Imparting hydrophobicity into a polyamide fiber has numerous benefits, including improved softness without impacting wear performance, improved ease of cleaning, reduced wicking, and reduced gel formation, as compared to the polyamide fibers without hydrophobicity. Additionally, imparting hydrophobicity to the polyamide fiber has surprisingly and unexpectedly been found not to affect other properties, such as boil-off water shrinkage and flammability. The polyamide fibers produced by the methods disclosed herein may be used in various applications, including as yarns, in knit, woven, and non-woven fabrics, in textiles, and in carpets. The polyamide fibers are especially useful for carpets and even for cut pile carpets, regardless of the faceweight of the carpet, e.g., the amount of fiber present in tufted carpet per unit area. According to the present disclosure, suitable fiber cross-sections may include, and not limited to, hollowfilaments, round, bi-lobal, tri-lobal, quad-lobal, penta-lobal, bicomponent, etc.

There are several methods that may be used to confirm or measure hydrophobicity in the polymer fiber. The term “hydrophobicity,” as used herein, is the material's property of being water-repellent; tending to repel and not absorb water. It is the opposite of hydrophilicity or the material tendency to having an affinity for water. Hydrophobicity [or hydrophilicity] may be determined from water contact angle measurements. Generally, if the water contact angle is larger than 90°, the solid surface is considered hydrophobic and if the water contact angle is smaller than 90°, the solid surface is considered hydrophilic. The contact angle is the angle, conventionally measured through the liquid [water in the case of water contact angle], where a liquid-vapor interface meets a solid material surface. The water contact angle of the polymer fibers described herein may range from greater than 90 to 130°, e.g., from 95 to 120°, or from 100 to 115°. In further aspects, hydrophobicity is determined by the ALR performance test, described herein. Hydrophobicity may also be determined via an aqueous liquid repellency (ALR) performance test. The test used in the examples disclosed herein is an adapted procedure from the AATCC 193-2007 method used for ALR testing. In some embodiments, the articles made from the fiber may have an ALR rating of at least 0, e.g., at least 1, at least 2, at least 3, or even greater.

In some embodiments, hydrophobicity may be imparted to the polymer fiber by including a modified polymer in the fiber, e.g., a modified polyamide. In some aspects, the polyamide is modified with a polyolefin. It is known, however, that compatibility of a polyolefin and a polyamide is poor. Therefore, reacting an olefin copolymer with maleic anhydride has been found to improve the compatibility of the olefin copolymer with the polyamide. Compatibility may be improved through other methods, including through functionalization via a glycidyl methacrylate, acrylic acid, or by use of a styrene acrylonitrile, merely to name a few examples.

In some embodiments, the fiber, e.g., the polyamide fiber, comprises a first polymer phase and a second polymer phase. In some aspects, the first polymer phase may be continuous. The first polymer phase of the disclosed fibers may comprise at least one polymer selected from polyamides and polyesters. Non-limiting examples of suitable polyamides may include aliphatic (or non-aromatic), aromatic, and partially aromatic polyamides. Aliphatic polyamides may include nylon-6, nylon-6,6, nylon-4,6, nylon-5,6, nylon-5,10, nylon-5,12, nylon-5,14, nylon 5,6,12, co-polyamides and blends thereof. Partially aromatic polyamides may include MXD6, Nylon-6/6T, Polyphthalamide (PPA), Nylon-6T, Nylon-61/6T, Polyamideimide, co-polyamides and blends thereof.

The published values of typical properties of such polyamides for use as the first polymer phase are listed in the table below:

| First Continuous | | Melting Point |
|---|---|---|
| Polymer Phase | Trade Name | Temp, Deg. C. |
| Nylon-6 | Various | ~220 |
| Nylon-6,6 | Various | ~260 |
| Nylon-4,6 | DSM Stanyl ® PA46 | ~290 |
| Nylon-5,6 | Cathay TERRYL ™ PA56 | ~254 |
| Nylon-5,10 | Cathay TERRYL ™ PA510 | ~218 |
| Nylon-5,6,12 | Cathay TERRYL ™ PA5612 | ~185 |
| MXD6 | Mitsubishi MXD6 | ~240 |
| Nylon-6/6T | EMS Grivory | ~295 |
| Polyphthalamide | Dupont Zytel ®, Sabic LNP | ~300 |
| (PPA) | | |
| Nylon-6T | Mitsui ARLEN ™ | ~310 |
| Nylon-6I/6T | EMS Grivory | ~325 |
| Polyamideimide | Solvay Torlon ® PAI | ~355 |
| Polyester | Auriga 1101 ® | ~260 |

*Melting Point Temp is determined using DSC measurements.

The first polymer phase may also include copolymers or mixtures of multiple partially aromatic polyamides. For example, MXD6 may be blended with Nylon-6/6T prior to forming a fiber. Furthermore, partially aromatic polymers may be blended with an aliphatic polyamide or co-polymers or mixtures of multiple aliphatic polyamides. For example, MXD6 may be blended with Nylon-6,6 prior to forming a fiber.

In some aspects, the second polymer phase may be at least partially immiscible with the first polymer phase. The second polymer phase may be distributed in the first polymer phase. The second polymer phase may be continuous or discontinuous. If continuous, the second polymer phase may be an interpenetrating network. From a cross-sectional view, if discontinuous, the second polymer may have the appearance of islands of the second polymer in a sea of first continuous phase polymer. From a cut view in the longitudinal direction of the fiber, the second polymer phase may be nanofibrils or nanocylinders, dispersed either discontinuously or continuously, in the first polymer phase. For a description of island-in-the-sea bicomponent fibers, see Journal of Engineered Fibers and Fabrics http://wwwjeffjournal.org Volume 2, Issue 4-2007.

In some embodiments, the second polymer phase comprises a polyolefin copolymer. The polyolefin copolymer may comprise at least one monomer unit selected from ethylene, propylene, and butylene; and the degree of maleation of the polyolefin copolymer can be from 0.01 to 10% by weight, based on the total weight of the fiber, e.g., from 0.02 to 8 wt. %, from 0.1 to 1.2 wt.%, or from 0.1 to 0.5 wt. %. Suitable polyolefin copolymers may be selected from the group consisting of polyolefins and polyacrylates. The polyolefin copolymer may be an ionomer. The polyolefin copolymer may have a core-shell structure. When modified by maleic anhydride, the polyolefin copolymer may be referred to as a maleated polyolefin copolymer. In some aspects, the polyolefin copolymer comprises at least one polar functional group. The polyolefin copolymer having at least one polar functional group may be a reaction product formed in the present of the first continuous polymer phase.

One method to determine whether the polyamide modification reaction described herein occurred is to measure the enthalpy of fusion. As explained in Example 1 below, a lower enthalpy of fusion for the modified polyamide as compared to the unmodified polyamide indicates that the reaction did in fact occur. In some aspects, the enthalpy of fusion for the modified polyamide, as determined by DSC analysis, is, on average, less than 65 J/g, e.g., less than 64 J/g, or less than 63.5 J/g as compared to an enthalpy of fusion for the unmodified polyamide of greater than 65 J/g. In some aspects, the enthalpy of fusion for the modified polyamide is at least 4% lower than for the unmodified polyamide, e.g., at least 5% lower, at least 6% lower, at least 7% lower, at least 8% lower, at least 9% lower, or at least 10% lower. In terms of ranges, the enthalpy of fusion for the modified polyamide is from 1 to 12% lower than for the unmodified polyamide, e.g., from 2 to 11%, from 3 to 10% or from 5 to 10%.

In some aspects, the fiber comprises from 1 to 300 ppm, by weight, of reacted polyamide-polyolefin copolymer, based on the total weight of the fiber, e.g., from 5 to 250 ppm. The ppm by weight of the reacted polyamide-polyolefin copolymer is based on the modification level of the functional polyolefin used and the weight percent of the additive used as explained further in Table 7. Further, the fiber may comprise from 1 to 200 ppm maleic anhydride units, based on the total weight of the fiber.

In some aspects, the first polymer phase, e.g., the first continuous polymer phase, comprises at least one polymer selected from polyamides and polyesters. The polyamide may be any of the polyamides disclosed herein. In some aspects, the polyamide is nylon-6 or nylon-6,6. When the polyamide comprises nylon-6, the degree of maleation of the polyolefin copolymer may range from 0.05 to 1.5 wt. %, e.g., from 0.1 to 1.4 wt. %, or from 0.15 to 1.25 wt. %, and the polyolefin copolymer may be present in the fiber from 0.1 to 10 wt. %, based on the total weight of the fiber, e.g., from 0.2 to 9 wt. % or from 0.25 to 8.5 wt. %. When the polyamide comprises nylon-6,6, the degree of maleation of the polyolefin copolymer may range from 0.05 to 1.5 wt. %, e.g., from 0.1 to 1.4 wt. %, or from 0.15 to 1.25 wt. %, and the polyolefin copolymer may be present in the fiber from 0.1 to 7 wt. %, e.g., from 0.25 to 6.5 wt. % or from 0.3 to 6 wt. %, based on the total weight of the fiber.

In some aspects, the fiber may comprise from 0.1 to 10 wt. % of a polyolefin copolymer, of which up to 8 wt. % includes at least one functional group. In this aspect, the fiber further comprises from 90 to 99.9 wt. % of a thermoplastic polyamide polymer. In some aspects, the total of the these two components adds up to 100 wt. %. In some further aspects, additional components, such as topical treatments, may be applied to the fiber. The thermoplastic polyamide fiber may be the reaction product of an aliphatic diacid and an aliphatic diamine, such as at least one of nylon-6, nylon-5,6, and nylon-6,6. The polyolefin copolymer may be selected from the group consisting of polyolefin, polyacrylate, and copolymers thereof. The polyolefin copolymer may be modified by one or more monomers. Surprisingly and unexpectedly, when the polyolefin copolymer is maleated, the maleated polyolefin is included at lower levels than previously believed effective to accomplish the desired results. In some aspects, only a modified polyolefin is present in the fiber, e.g., the fiber does not contain a polyolefin other than the modified polyolefin. Specifically, in these aspects, only a maleated polyolefin is present in the fiber. As discussed further herein, the maleated polyolefin is present in the second polymer phase. Thus, the second polymer phase may consist of the modified polyamide, which is the reaction product of the polyamide and the modified polyolefin. In some aspects, there may be some residual unreacted polyolefin, though this is not a separately added component.

The denier per filament (dpf) of the polymer fiber described herein may vary. The term “dpf” or “DPF”, as used herein, means a unit measure of mass density of fiber, called denier per filament. One denier per filament (1 dpf) equals one gram of fiber per 9000 liner meters of fiber. 10 dpf equals 10 g fiber per 9000 linear meters of fiber length. Generally, the dpf is 40 or less, e.g., 35 or less, or 30 or less. In terms of ranges, the dpf may range from 1 to 40, e.g., from 2 to 35, or from 2 to 30. In some aspects, depending on which polyamide polymer is used in the first phase, the dpf may be lower. For example, the dpf may range from 1 to 18, e.g., from 1 to 15, from 1 to 12, or from 1 to 8.

In some embodiments, the second polymer phase may have a Melt Flow Index (MFI) as measured by ASTM D1238 (190° C./2.16 kg) from 0.25 g/10 min to 20.0 g/10 min, e.g., from 0.5 g/10 min to 15.0 g/10 min, or from 1.0 g/10 min to 12.0 g/10 min.

In some embodiments, the second polymer phase is distributed in the first polymer phase, e.g., the first continuous polymer phase, in domains. The domains may be measured by Scanning Electron Microscopy (SEM). In some aspects, the domains are nano-scale domains from a cross sectional diameter measure. The nano-scale domains may range from 5 to 500 nm in cross sectional diameter, e.g., from 9 to 400 nm. In some aspects, the domains are measured by longitudinal length and may range from 50 to 6000 nm in longitudinal length, e.g., from 100 nm to 5000 nm.

The modified fibers disclosed herein may have improved mechanical properties as compared to unmodified fibers. In some aspects, a lesser tenacity and a greater elongation at break were seen for the modified fibers as compared to the unmodified fibers. For example, the modified fibers may have a tenacity of less than 2.32 gf/den, e.g., less than 2.25 gf/den, less than 2.20 gf/den, less than 2.15 gf/den, less than 2.10 gf/den, less than 2.05 gf/den, or even less than 2.0 gf/den. In general, trilobal fibers were found to have lesser tenacities than bilobal fibers. In terms of change in tenacity, the modified fibers had a reduction in tenacity of at least 5% as compared to the unmodified fibers, e.g., at least 7.5%, at least 10%, or at least 12.5%. The modified fiber may also have an elongation at break percentage of at least 80%, e.g., at least 85%, at least 90%, at least 94%, or at least 100%. In terms of change in elongation at break percentage, the modified fibers had an increase in elongation at break percentage of at least 90% as compared to the unmodified fibers, e.g., at least 95%, at least 100%, at least 105%, at least 110%, at least 115%, or at least 120%.

Compressibility of the modified fiber, in yarn form, was also improved relative to the unmodified fiber having the same base components. The degree of compression may be influenced by adjusting the degree of modification of the fiber, e.g., the additive level of the polyolefin copolymer and/or the degree of maleation, and also by modifying the dpf of the fiber.

In some aspects, the modified fibers have superior softness as compared to unmodified fibers of the same or of lower dpf and as compared to the same or different cross sectional shape of the fiber (such as bilobal compared to trilobal). This result is surprising and unexpected because typically lower dpf fibers, especially in carpet samples, are softer. Measures to quantify the softness are disclosed in Example 2.

In view of the improved softness of the modified fibers and compared to unmodified fibers, it was expected that the durability of the modified fibers would be less than the durability of the unmodified fibers. Surprisingly and unexpected, the opposite was found. Instead of reduced durability, the durability of the modified fibers was equal to or superior to the durability of the modified fibers. The same improvements in durability were also seen over 10k and 15k cycles. Full testing information is described in Example 3.

The modified fibers of the present disclosure also had superior wicking performance, i.e., resistance against wicking, as compared to unmodified fibers. The superior wicking performance was seen over a period of sixty minutes.

Greater resistance to staining was seen for the modified fibers as compared to the unmodified fibers across varying base polyamides and across varied amounts of modified polyolefin. In some aspects, from 0.01 up to less than 2.5 wt. % polyolefin additive resulted in a near-surface stain of the fibers, as compared to complete penetration of the fibers when 0.0 additive was added. In some aspects, when from 2.5 to less than 3.5 wt. % polyolefin additive was included, the fibers had a less near-surface stain, as compared to complete penetration of the fibers when 0.0 additive was added. When 3.5 wt. % or greater additive was added, only the tips of the fibers were stained, as compared to complete penetration of the fibers when 0.0 wt. % additive was added.

In addition to resistance to staining, the odor rating of the modified fibers was improved as compared to the unmodified fibers of the same base materials and as compared to other commercially available sample. The improved odor rating, indicating that no odor was observed over a period of time after a stain solution was applied to the fibers and then cleaned, illustrates that little to none of the stain solution absorbed into the carpet or remained after cleaning.

Moisture absorption of the modified fibers was also improved as compared to the unmodified fibers. For example, even at a lesser dpf than the unmodified fiber, the drying time of the modified fiber may be less than the drying time of the unmodified fiber, e.g., by at least 2 minutes at 150° C., by at least 3 minutes, by at least 4 minutes, or by at least 5 minutes.

For bulked continuous filaments (BCF), the additive level of the modified polyolefin may influence the aqueous liquid repellency rating (ALR), described further herein. For example, by adding even just 1.0% additive to the modified fiber, the ALR rating may be increased from 0 to 3 for both cut pile and loop pile constructions. This improvement may be seen over variety of faceweights, ranging from 18 to 45 ounces and at dpf values up to 30, e.g., up to 25, up to 20, or up to 17. This improvement is also seen over a variety of fiber cross-sections, including hollowfilaments, round, bi-lobal, quad-lobal, penta-lobal, bicomponent, etc. Further, there is no functional limit on the additive level other than cost and complexity of adding the additive. As described herein, additive content from 0.01 to 10 wt. % may be one range used. The modification level in the additive itself may vary, as may the calculated ppm (by weight) of the reacted polyamide-polyolefin copolymer. Nonlimiting commercial examples are shown in Table 7.

In some embodiments, when the fibers are spun into yarn, the ALR rating of the yarn formed from the modified fibers is improved as compared to the yarn formed from the unmodified fibers. For example, the ALR rating may be increased from 0 to 1, from 0 to 2, or from 0 to 3. This is true over a broad range of base polymers, additive levels, and dpf's. Additionally, this result is seen even without any topical treatments applied to the modified or unmodified fibers, though topical treatments may be applied, especially for higher dpf samples. The same result is also seen when the fibers are made into carpet samples, including cut pile construction carpets.

The modified fibers further showed improved repellency performance testing after hot water extraction as compared to unmodified fibers. Even after up to three passes through a hot water extraction test, the ALR remained the same or improved. Additionally, for the modified fibers, wicking was not observed after the hot water extraction whereas it was observed for the unmodified fibers. Another measure for hydrophobicity testing, a force tensiometer, showed that the modified fibers had a decreasing force over the measurement of the tensiometer whereas the unmodified fibers had the same or an increasing force. In some aspects, the measured force (in mN) of the modified fiber on the tensiometer at 30 seconds was less than 0 mN, e.g., less than −0.01 mN, e.g., less than −0.1 mN, or less than −0.2mN. In some aspects, the measured force (in mN) of the modified fiber on the tensiometer at 60 seconds was less than 0 mN, e.g., less than −0.05 mN, e.g., less than −0.1 mN, less than −0.2 mN, less than −0.3 mN, or less than -0.4 mN. In some aspects, these results may be seen for fibers having up to 12 dpf.

### Gel Formation

In the present disclosure, suppressed gel formation was also unexpectedly observed. Herein, gel formation is defined as a thermal degradation cross-linking reaction of the nylon materials, such as nylon-6. The mechanism of gel-forming in nylon-6,6 is complex and is not fully understood. When efforts to suppress gel formation are successful, the desired gel suppression may typically result in fewer breaks and lower overhaul time. Fewer breaks and lower overhaul time results in an increased yield for the manufacturer through reducing gel-sluff events and providing the asset with longer overall life between required maintenance shutdowns.

There are at least two ways to quantify gelation. In some aspects, the maximum force applied to maintain the same screw speed in a micro-extruder and gel-time are measured. Further details are provided in Example 8. When a force of 7500 Newtons is applied, the modified polyamide may have a gel time of greater than 19 hours, e.g., greater than 20 hours, greater than 25 hours, greater than 30 hours, greater than 35 hours, or greater than 40 hours. In terms of ranges, the gel time may range from 20 to 80 hours, e.g., from 25 to 75 hours, from 30 to 70 hours, from 35 to 65 hours, or from 40 to 60 hours. This may be compared to an unmodified polyamide of the same other base components, which has a gel time at 7500 Newtons of 19 hours.

In another method of quantifying gelation, screw speed may be set, such as at 20 RPM, and the force required to turn the screw may be measured over time. In some aspects, the force required to maintain a screw speed of 20 RPM was less than 525 Newtons over a period of 30 seconds, e.g., less than 450 Newtons, less than 425 Newtons, less than 400 Newtons, or less than 390 Newtons. As the additive level for the modified polyolefin increased, the force reduced even further. For example, when from 0.01 to 1 wt. % additive was included, the force was less than 390 Newtons. When from 1.0 wt. % to 2 wt. % additive was included, the force was less than 375 Newtons, e.g., less than 350 Newtons, less than 325 Newtons, less than 300 Newtons, or less than 380 Newtons. When from 2.0 wt. % to 3 wt. % additive was included, the force was less than 275 Newtons, e.g., less than 270 Newtons, less than 265 Newtons, less than 260 Newtons, or less than 250 Newtons. When 3 wt. % or greater additive was included, the force was less than 250 Newtons, e.g., less than 240 Newtons, less than 230 Newtons, less than 220 Newtons, or less than 215 Newtons. These values are compared to a force of 525 Newtons required for an unmodified polyamide of the same other base components. The reduction in force needed was surprising and unexpected, especially in view of the relatively small amounts of additive that were used to decrease the force needed.

In some aspects, the composition comprising a first polyamide phase, e.g., a continuous phase, and a second discontinuous phase comprising polyolefin copolymer has reduced polymer-to-metal adhesion during manufacture. This applies whether the composition is melted or in the form of a fiber.

Accordingly, the present disclosure is also related to a method for reducing the gelation rate of a condensation polyamide. The method comprises providing a condensation polyamide and adding from a maleated polyolefin copolymer to the condensation polyamide. As disclosed herein, the composition may comprise from 0.1 to 10 wt. % of a polyolefin copolymer, e.g., a maleated polyolefin copolymer, and the degree of maleation in the polyolefin copolymer may range from 0.05 to 1.5 wt. %. In some aspects, the polyamide comprises nylon-6,6, though other polyamides disclosed herein may be used in addition to or in place of nylon-6,6.

### Maintained Characteristics

In addition to the advantages enumerated herein, some properties remained essentially the same in the modified fibers as compared to the unmodified fibers. These lacks of changes were surprising and unexpected. In some aspects, such as when the polyamide is nylon-6, the steam heatset shrinkage of the fiber is greater than 20% and the boil off water shrinkage is essentially unchanged (less than a 5% difference, e.g., less than a 4% difference, less than a 3% difference, less than a 2% difference, less than a 1% difference, or less than 0.1% difference). In some aspects, when the polyamide is nylon-6,6, the steam heatset shrinkage of the fiber is less than 20% and the boil off water shrinkage is essentially unchanged (less than a 5% difference, e.g., less than a 4% difference, less than a 3% difference, less than a 2% difference, less than a 1% difference, or less than 0.1% difference). Additionally, flammability of the fibers remained essentially unchanged (less than a 10% difference, e.g., less than an 8% difference, less than a 6% difference, less than a 5% difference, less than a 3% difference, or less than 1% difference).

### Hydrophobic Carpet

In some aspects, the present disclosure is directed to a hydrophobic carpet comprising a polyamide and a maleated polyolefin copolymer. In some embodiments, the polyamide is nylon-6,6. In these embodiments, the hydrophobic carpet may have an ALR value of at least 0, a degree of maleation from 0.1 to 1.5 wt. %, and from 0.2 to 9 wt. % polyolefin copolymer, based on the total weight of the carpet. In further aspects, the polyamide may be any polyamide disclosed herein, including nylon-6 and nylon-5,6. The hydrophobic carpet may have at least one of the following characteristics when compared to a carpet prepared from a carpet comprising just the polyamide (and no maleated polyolefin copolymer): a) equal or improved durability when measured according to the Vetterman 5/10/15K Drum testing ASTM D5417-05, b) improved water repellency preservation after Hot Water Extraction [HWE] conditions, c) suppressed liquid spill absorption on surface, d) reduced drying time, e) suppressed staining and sub-surface stain penetration, f) improved odor resistance, and g) equivalent flammability performance. Any combination of these characteristics may be met, including at least any two, three, four, five, six, or all seven characteristics. At least some of these characteristics are true not only for the fibers when used in a carpet, but are true for the fiber regardless of use.

In the carpet industry, and especially residential carpet products, “Durability of Fiber” is graded by testing a carpet specimen in Vetterman Drum Testing, where a rating of 3 or higher is desirable upon simulated 5000-steps foot traffic. Samples comprising the modified fibers according the present disclosure have a rating of 3 or higher.

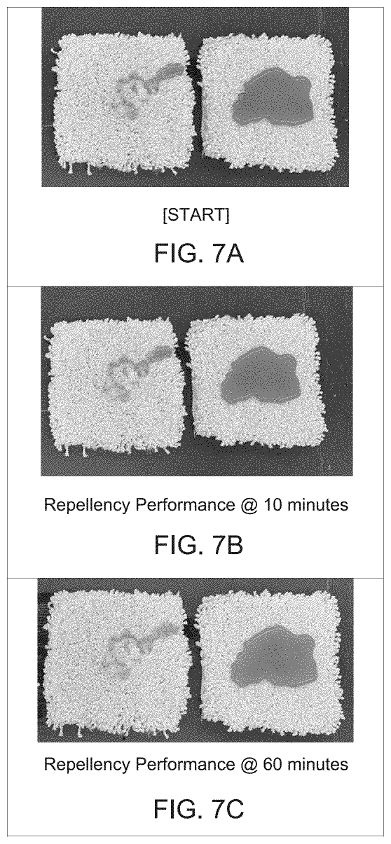

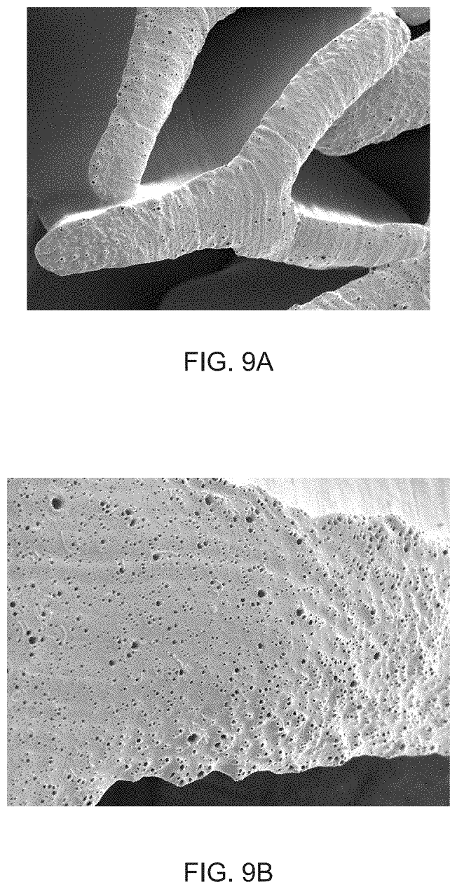

Cleanability for a carpet specimen may comprise of three components: (i) Water resistance/hydrophobicity—resulting in increased window to clean before potential for staining, increased drying time, and lower mold/mildew growth potential, (ii) No/low wicking (reducing the ability for an existing stain behind the carpet to migrate back to the visible surface), and (iii) stain resistance—resulting in less contamination adhering to fibers. Also, equally desirable is preventing the stain on the carpet surface from spreading, resulting in a smaller area that requires cleaning. Surprisingly and unexpectedly, the fibers of the present disclosure have greatly improved cleanability according to all three components, as compared to fibers that have not been modified as disclosed herein. As discussed below, FIGS. 7 and 9 show this mostly clear from a visual perspective. Instead of absorbing or soaking into the carpet, the spilled staining liquid remains essentially on top of the carpet fibers. Wicking and stain resistance are discussed further herein.

The present disclosure will be better understood in view of the following non-limiting examples.

### General Procedures for Examples

Fibers were produced of Nylon-6, and Nylon-6,6 via conventional melt spinning extrusion (detailed as shown in example 11).

Nylon 5,6 fibers were produced using a monofilament microscale extruder.

Carpet samples were prepared via conventional twisting, heat-setting and tufting procedures that are known and practiced in the carpet industry.

No objective, standardized test method exists to characterize carpet specimen feel. For the carpet feel evaluation, hand panels were conducted as follows: A panel of 11 participants were selected to rank the softness of 6 carpet samples. The samples were anonymously labeled and randomly distributed in a line. Participants compared the samples by touching them with the palm side of their hands, folding and unfolding their fingers, and pressing down on the carpet sample to detect softness differences. Participants were asked to force-rank the samples from one to six with one being the softest and six being the harshest.

### Materials Used in Examples

PA sources—Nylon-6,6: The nylon-6,6 material used to make polyamide samples and modified polyamide samples were produced in-house using standard commercial production methods and procedures. The Nylon-6 material used to make polyamide samples and modified polyamide samples was commercially available from BASF.

Nylon-6: The nylon-6 material used to make Control polyamide 6 and modified polyamide 6 samples is a commercially available nylon-6, such as Ultramid° Nylon-6 from BASF.

Nylon-5,6: The nylon-5,6 material used to make Control polyamide 5,6 and modified polyamide 5,6 knit samples is commercially available from Cathay Industrial Biotech Ltd.

Polyolefin copolymer—a variety of modified polyolefins are commercially available. These may include, but are not limited to, AMPLIFY™ GR Functional Polymers commercially available from Dow Chemical Co. [Amplify™ GR 202, Amplify™ GR 208, Amplify™ GR 216, Amplify™ GR380], Exxelor™ Polymer Resins commercially available from ExxonMobil [Exxelor™ VA 1803, Exxelor™ VA 1840, Exxelor™ VA1202, Exxelor™ PO 1020, Exxelor™ PO 1015], ENGAGE™ 8100 Polyolefin Elastomer commercially available from Dow Elastomer, Bondyram® 7103 Maleic Anhydride-Modified Polyolefin Elastomer commercially available from Ram-On Industries LP, and such. Table 7 lists some non-limiting commercially available modified polyolefins that may be useful according to the present disclosure.

The following Examples demonstrate the present invention and its capability for use. The invention is capable of other and different embodiments, and its several details are capable of modifications in various apparent respects, without departing from the scope and spirit of the present invention. Accordingly, the Examples are to be regarded as illustrative in nature and not as restrictive. Likewise, the below Examples illustrate non-limiting modes of carrying out the disclosed process with the particular arrangement of the units as described above. All percentages are by weight unless otherwise indicated.

Each of the below modified polyamide samples has a first continuous first polymer phase containing the described polyamide (N6, N6,6, or N5,6) and a second polymer phase comprising the additive disclosed (a modified polyamide).

### EXAMPLE 1

A differential scanning calorimetry or DSC analysis was performed for samples according to the present disclosure and control. Non-isothermal DSC analysis was conducted from a range of 20° C. to 300° C. at a rate of 20° C./min for both a polyamide control and the modified polyamide disclosed herein. The polyamide control was an unmodified nylon-6,6. The modified polyamide contained about 3.5 wt. % modified polyolefin (VA-1840).

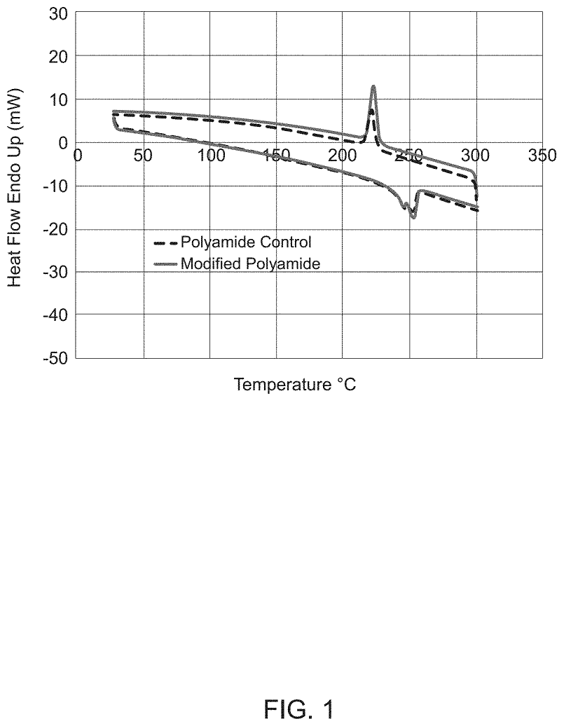

By sample replicates, the enthalpy of fusion from the DSC analysis was determined to be, on-average, 61.1 J/g [from three replicates 59.6, 60.7, 63.1] for the modified polyamide samples according to the present disclosure versus 67.2 J/g [from three replicates 65.3, 65.8, 70.4] for the non-modified polyamide control. FIG. 1 represents the measured DSC curves for samples according to the present disclosure [gray solid line] versus Control [black dashed line]. The X-axis is temperature in degrees Celsius and the Y-axis is heat flow in mWatts [or mW].

It was observed that the enthalpy of fusion for the modified polyamide samples according to the present disclosure was lower than that for the non-modified polyamide Control sample. This data indicates that the polyamide modification reaction occurred, resulting in the modified polyamide according to the present disclosure.

### EXAMPLE 2 [a-d]: Hand Panels Softness Test

For samples according to the present disclosure and other conventional samples, two hand panel softness tests were performed. For each panel, 11 participants were selected to rank the softness of four carpet samples. The samples were anonymously labeled and randomly distributed in a line. Participants were asked to force-rank the samples from one to six with one being the softest and six being the harshest.

TABLE 1 below provides the data summary for the specimens tested. The polyamide control was an unmodified nylon-6,6. The modified polyamide contained about 3.5 wt. % modified polyolefin (VA-1840). The rankings ranges from 1 to 6, where 1 indicates the softest specimen and 6 indicates the harshest.

TABLE 1

| | | Average | | |
|---|---|---|---|---|
| Sample | | Ranking | | Final |
| ID | Sample Description | Panel 1 | Panel 2 | Rank |
| 2 (a) | Polyamide trilobal Control (4 DPF) | 3.4 | 4.1 | 3.7 |
| 2 (b) | Polyamide trilobal Control (8 DPF) | 5.8 | 6.0 | 5.9 |
| 2 (c) | Polyamide Control bilobal | 3.9 | 3.2 | 3.6 |
| | Cross Section (8 DPF) | | | |
| 2 (d) | Modified Polyamide with | 2.1 | 2.2 | 2.1 |
| | bilobal Cross Section (8 DPF) | | | |

Although it is known in the field that lower denier-per-filament [DPF] is softer, it was surprisingly observed that the carpet specimens prepared according to the present disclosure [Example 2(d)] ranked superior in softness versus the Control specimen [Polyamide Control (4 DPF) 2(a)]. As seen in Table 1, the modified polyamide had a carpet hand softness ranking of 3.0 or less as ranked by two different panels. This represented more than a 50% improvement in softness as compared to any of the control samples, even the 4 DPF carpet samples.

### EXAMPLES 3 [a-b]

### Vetterman Drum Tests for Durability Determination

In the carpet industry, durability for polyamide carpets is commonly graded via Vetterman Drum Testing method ASTM D 5417 (2016). This Vetterman Drum Testing was conducted using a 28.75-inch diameter rotating drum that carpet samples of similar pile height were placed into. A 16-pound (lb.) ball with polyurethane studs tumbled inside the drum to simulate traffic and wear. The resulting carpet was then rated on a scale of 1-5, based on visual matting and tip definition. A performance rating of 3 or higher is desired for 5,000 (5K) cycles.

Vetterman Drum testing was conducted for several specimens, prepared according to the present disclosure, and which were tested for durability and the performance rating was compared against their corresponding Control specimens at 5,000 (15K), 10,000 (10K) cycles and 15,000 (15K) cycles of foot traffic. In the fiber and yarn industry, bilobal and trilobal cross sections are generally known and most commonly used.

Table 2 below summarizes the test results obtained from Vetterman Drum Testing. The polyamide control was an unmodified nylon-6,6. The modified polyamide contained about 3.5 wt. % modified polyolefin (VA-1840).

TABLE 2

| | | | Vetterman Drum | | |
|---|---|---|---|---|---|
| | | Denier-per- | Testing | | |
| Example | Specimen | Filament, | 5 K | 10 K | 15 K |
| No. | Description | Cross-Section | Cycles | Cycles | Cycles |
| 3 (a) | Polyamide | 8-DPF, | 3.5 | 3.2 | 3.2 |
| | Control | Bilobal | | | |
| 3 (b) | Modified | 8-DPF, | 3.8 | 3.5 | 3.5 |
| | Polyamide | Bilobal | | | |

Surprisingly and unexpectedly, it was observed that the specimens according to the present disclosure [Example 3(b)] showed superior durability rating compared to the Control counterpart [Examples 3(a)]. Typically, any fiber modifications to enhance softness of the resulting fiber article would negatively impact article's durability. It was surprisingly observed that the embodiments of the present disclosure preserved and improved both the article's durability and softness [see Example 2 and Table 1].

### EXAMPLE 4

### SEM Analysis

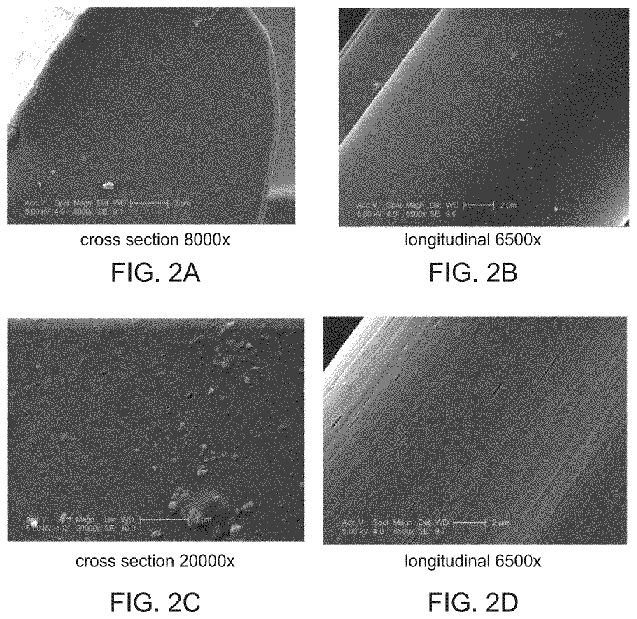

Scanning Electron Microscope [SEM] analysis was performed for the fiber samples prepared according to the present disclosure. An FEI XL30 Environmental SEM [Manuf.: Phillips] was used to view the samples. The samples were treated as described below, and then sputter coated with a thin layer of gold to be observable in the ESEM. FIGS. 2 [A-D] show the SEM visual representation of samples tested. FIG. 2[A] is a cross-sectional view at 8000×magnification and FIG. 2[B] is a longitudinal view at 6500× magnification of the treated Polyamide Control. FIG. 2[C] is a cross-sectional view at 20000× magnification and FIG. 2[D] is a longitudinal view at 6500× magnification of the treated Modified Polyamide. The SEM views of the treated Polyamide Control and the treated Modified Polyamide show the modified polyamide exhibits regions of nano-scale fibrils dispersed within the polymer matrix. The polyamide control was an unmodified nylon-6,6. The modified polyamide contained about 3.5 wt. % modified polyolefin (VA-1840).

It was observed that the second polymer phase (polyolefin) was distributed in the first continuous polymer phase via domains as measured by Scanning Electron Microscopy ranging from 9 nm to 400 nm in cross sectional diameter (FIG. 2C) and 100 nm to 5000 nm in longitudinal length (FIG. 2D). The term “nm” is an abbreviation for length unit “nanometer”.

Treating of the fiber samples for SEM imaging was done as follows: Samples of the Polyamide Control and Modified Polyamide were immersed in Trichlorobenzene and put in a Branson 2210 ultrasonic cleaner for a total of 30 minutes. At the 30 minute midpoint, fresh trichlorobenzene was added and the procedure continued. This allowed the dissolution of the olefin modification as shown by the pitting in SEM analysis. Without this treatment, the domains could not be seen or detected.

### EXAMPLE 5

### Resistance Against Wicking

A simple visual test was performed using carpet fiber tufts using of the 8dpf, nylon-6,6, trilobal, 45 oz/yd² carpet, according to the present disclosure, and the wicking performance was compared against the Control specimen. The polyamide control was an unmodified nylon-6,6. The modified polyamide contained about 3.5 wt. % modified polyolefin (VA-1840).

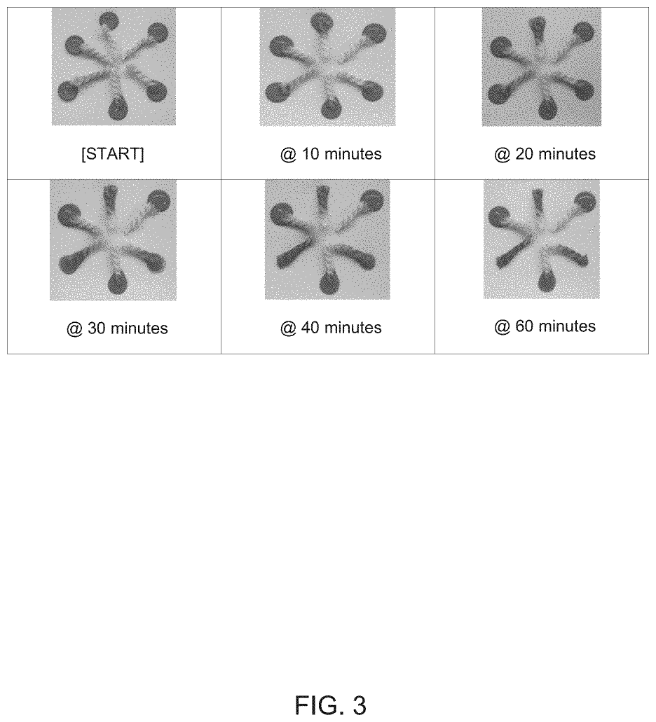

FIG. 3 is a visual representation of the time-evolved wicking performance for the tested specimens. The specimens were arranged as shown in FIG. 3 such that the modified polyamide specimens prepared according to the present disclosure formed the “Y” formation, while the Control specimens formed the “Inverted Y” formation for clear and easy comparison. Drops of a colored liquid, simulated by red Kool-Aid® aqueous solution, were put in intimate contact with the outside ends of these specimens [See FIG. 3 START] and the wicking of red colored liquid in the specimen pieces was photographically monitored for the total time of 60 minutes with intermittent photos taken at 10 minutes, 20 minutes, 30 minutes, 40 minutes and 60 minutes, from the Start time Zero.

It was observed that the modified polyamide specimens according to the present disclosure, i.e., the “Y” formation specimens, showed superior performance in resistance against wicking versus the unmodified polyamide Control specimens in the “Inverted Y” formation. These Control specimens turned red from the wicking action of the red liquid (and the drops at the “Inverted Y” specimen ends depleted). Although FIG. 3 is in grayscale, the difference between the modified polyamide specimens and the unmodified polyamide Control specimens is very clear.

### EXAMPLE 6 [a-d]

### Resistance Against Staining

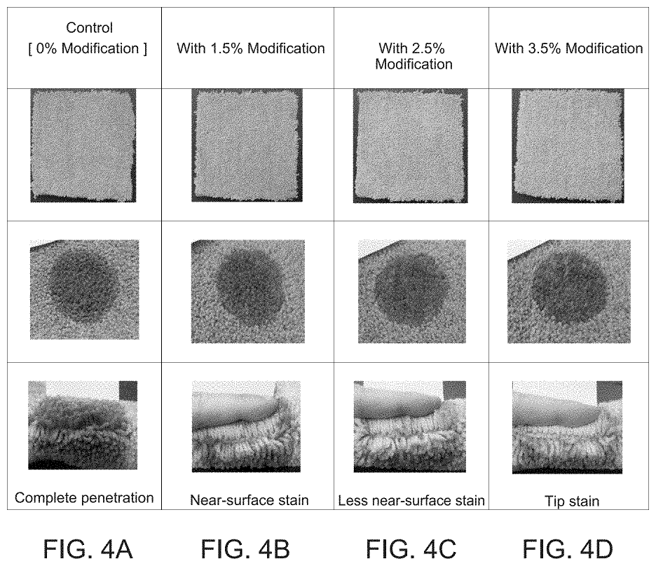

In this example, 8 dpf, nylon-6,6, trilobal, 45 oz/yd² carpet specimens were tested for resistance against staining and compared against the Control specimen. The polyamide control was an unmodified nylon-6,6. The modified polyamide contained modified polyolefin (VA-1840) in varying levels as shown in FIG. 4.

FIG. 4 is a visual representation of the resistance to staining for the tested specimens [see FIG. 4 second row]; 6(a) being the Polyamide Control specimen having the 0 wt. % modification and 6(b) through 6(d) being the Modified Polyamide specimens with varying modification levels as shown in FIG. 4. Stains of a colored liquid, simulated by red Kool-Aid® aqueous solution, were put in intimate contact with the top surface of these specimens [See FIG. 4 third row]. The colored liquid was allowed to seep through each specimen for 24 hours and stain the fibers at ambient indoor conditions. For each specimen, penetration of staining into the internal structure was visually inspected by gently folding the top surface and propping open the specimen fibers with a finger [see FIG. 4 fourth row].

It was observed that the specimens of the present disclosure stained at or very near to the top surface compared against the Polyamide Control in FIG. 4(a) for which the penetration was deep and all the way through the fibers. Again, although the Figures are in grayscale, the difference in penetration is still apparent. With further modification of the polyamide, the penetration depth of colored liquid stain was reduced as shown in FIGS. 4(b)-(c). This is a desired end-use performance improvement such that any liquid spills on the surface of the modified polyamide fiber carpet penetrate very short distances and not all the way to carpet backing material. This makes such carpet products better suited for enhanced cleanability and ease of spill cleaning.

### EXAMPLE 7

### Flammability Performance Testing

Test method ASTM D2859 (2016) or the Methenamine pill test was conducted on the modified polyamide disclosed herein and a polyamide control to determine if the polyamide modification had any impact to the fiber or article flammability. The polyamide control was an unmodified nylon-6,6. The modified polyamide contained about 3.5 wt. % modified polyolefin (VA-1840).

Table 3 below summarizes the flammability test results, i.e., uncharred area in inches, for the carpet specimen (8 dpf, nylon-6,6, trilobal, 45 oz/yd2) of the present disclosure versus the Control. Eight replicates of each specimen, i.e., modified polyamide of the present disclosure and Control, were put through these tests. The testing was performed on the face side of these specimens. The flame retardancy performance was not changed with the modified polyamide as compared to the control polyamide. In other words, the flame resistance performance of the fiber described herein was not decreased as compared to a fiber only having the first continuous polymer phase (thus not having the second polymer phase).

TABLE 3

| | Uncharred Area (in inches) | | | | | | | |
|---|---|---|---|---|---|---|---|---|
| Control Polyamide | 3.5 | 3.4 | 3.1 | 3.4 | 3.4 | 3.5 | 3.4 | 3.5 |
| Specimen [Modified PA] | 3.3 | 3.4 | 3.2 | 3.1 | 3.3 | 3.5 | 3.5 | 3.2 |

### EXAMPLE 8

### Gel Time for N6,6 Modified Polyamide

Gelation has been a problem with Nylon-6,6 since melt flow extrusion with the material began. Micro-extrusion studies were conducted with Xplore 15 ml HT Micro Compounder [Model No. Xplore MC 15 HT] to determine if the melt flow rheology had changed for the modified polyamide specimen vs. the polyamide control specimen.

An experiment was conducted in which the twin-screw micro-extruder was locked in closed loop recycle and held at 280° C. under Nitrogen. The screws were turned at a constant speed of about 25 RPM, and the force [measured in Newtons] required to maintain that speed was monitored over time. Eventually, as gelation occurred, the force required would exponentially increase and force-stop the screws. This was determined as the Gel-Time for that specimen.

Table 4-A below lists the maximum force [in Newtons] and Gel-Time [in hrs.] measured for the polyamide control and the Modified Polyamide according to the present disclosure. The polyamide control was an unmodified nylon-6,6. The modified polyamide contained about 3.5 wt. % modified polyolefin (VA-1840).

TABLE 4-A

| | Force | |
|---|---|---|
| Specimen | (Newtons) | Gel-Time (hr.) |
| Polyamide Control | 7500 | 19 |
| Modified Polyamide | 7500 | 42 |

It was observed that modification of polyamide [Nylon-6,6 in this example] as disclosed herein surprisingly reduced the rate at which gelation occurred. This reduced gelation effect is evident from a longer Gel-Time value of 42 hrs. measured for Modified Polyamide versus 19 hrs. for Polyamide Control at a maximum force of 7500 N.

Separate experiments were conducted on the above micro-compounder at a constant screw spend of 20 RPM and the force (in Newtons) was measured for modified nylon-6,6 polyamide specimens and nylon-6,6 polyamide control specimen. The modified nylon-6,6 polyamide specimen contained a modified polyolefin having VA-1840 as an additive. The control specimen contained no additive. The wt. % addition level listed in Table 4-B is for the modified polyolefin in nylon-6,6 based on the total polyamide weight.

About 10 g of each specimen in the melt form was run at 20 RPM screw speed in the micro-compounder with continuous closed-loop recycle at 280° C. under nitrogen. The force measurement data was collected about 30 seconds after specimen loading.

TABLE 4-B

| | Addition Level | |
|---|---|---|
| specimen | (wt. %) | Force (Newtons) |
| Polyamide Control | — | 525 |
| Modified Polyamide | 0.5 | 385 |
| | 1.0 | 275 |
| | 2.0 | 245 |
| | 3.0 | 210 |

Within a set time period (30 seconds), the polyamide control specimen required 525 N force at a constant 20 RPM screw speed. As the addition level in the modified polyamide specimen increased, the required force at 20 RPM continued to drop. A lower force requirement at the same extrusion speed condition is an indication of reduced wall shear effects, possibly from reduced gelation tendency exhibited by the modified polyamide specimens. It is usually observed that polyamide melts with lower gelation tendency may be processed with lower extrusion forces compared to those having higher gelation tendency at equivalent extrusion conditions. The Table 4-B data is a direct indication of reduced gelation effects of the modified nylon-6,6 specimens, according to the present disclosure.

Another surprising observation during clean-up of the experiments was that the gel formation layer detached effortlessly from the metal surfaces in the micro-extruder. Typically, when polyamide such as nylon-6,6 is gelled in this way, the gel layer removal/clean-up requires soaking of the extruder screws in an acidic medium. The observed ease of gel formation layer detachment in this example may indicate that modified polyamide material adhesion to metal surfaces was favorably modified. This suggests a potential benefit with cleaning/overhaul of extruder assets with lowered costs.

### EXAMPLES 9 [a-d]

### Mechanical Analysis

Mechanical Analysis was conducted via Instron on the Polyamide Control fibers and the Modified Polyamide fibers disclosed herein to examine any potential impact to the modulus of the fiber. The polyamide control was an unmodified nylon-6,6. The modified polyamide contained about 3.5 wt. % modified polyolefin (VA-1840). The Instron procedure used in these examples follows test method ASTM D2256 (2015). The samples tested included an 8-DPF Trilobal Polyamide Control, an 8-DPF Bilobal Polyamide Control, an 8-DPF Trilobal Modified Polyamide, and an 8-DPF Bilobal Modified Polyamide. All samples had the same total denier of 1000 g/den.

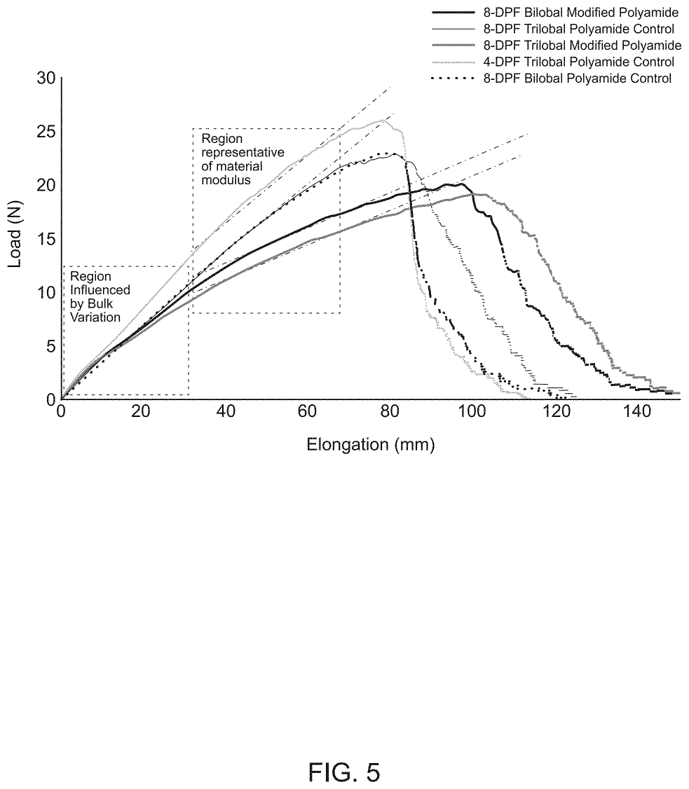

The mechanical analyses were conducted with a set gauge length and standard sample length. A set tension was not applied, rather the tension was zeroed after the samples were mounted at the set gauge length. Because of this, the influence of bulk variation may be seen in the experimental data. The region of this influence is indicated in FIG. 5.

A lower tenacity and higher elongation at break is measured in the Modified Polyamide samples [See Examples 9(b) and 9(d)] as compared to the Polyamide Control samples [Examples 9(a-c)] as shown in Table 5 below. The corresponding Load [in Newtons] versus Elongation [in mm] data for the Example 9 samples is represented in FIG. 5.

TABLE 5

| | | | | |
|---|---|---|---|---|
| Example No. | 9 (a) | 9 (b) | 9 (c) | 9 (d) |
| Sample | 8-DPF Trilobal | 8-DPF Trilobal | 8-DPF Bilobal | 8-DPF Bilobal |
| | Polyamide Control | Modified Polyamide | Polyamide | Modified Polyamide |
| | | | Control | |
| Tenacity | 2.32 | 1.95 | 2.34 | 2.04 |
| (gf/den) | | | | |
| % Change in | — | −16 | — | −13 |
| Tenacity | | | | |
| Elongation at | 79.76 | 100.37 | 78.66 | 94.62 |
| Break (%) | | | | |
| % change in | — | 126 | — | 120 |
| Elongation at | | | | |
| Break | | | | |
| Load at Break | 2320.14 | 1949.15 | 2336.36 | 2037.72 |
| (gf) | | | | |
| Tensile Strain | 47.47 | 59.75 | 46.82 | 56.32 |
| at Break | | | | |
| Data Curve | Light Gray Solid | Medium Gray | Black Dashed | Black Thick |
| in FIG. 5 | Line | Thick Solid Line | Line | Solid Line |

Each of the Modified Polyamides had superior elongation as compared to the Control Polyamides.

### EXAMPLE 10

### Yarn Compressibility

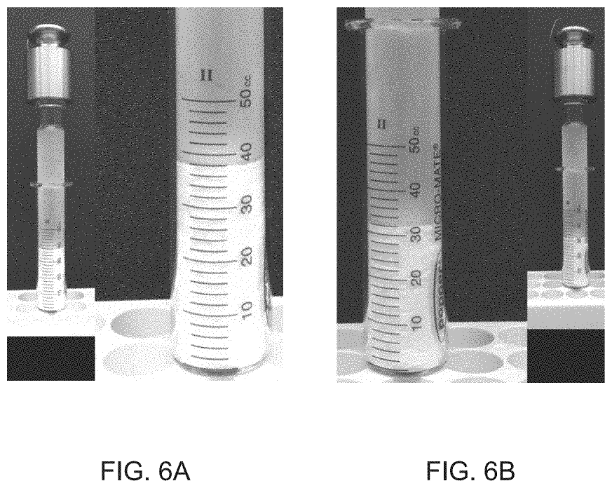

In this example, about 5 grams of 4 dpf Polyamide Control fiber specimen and about 5 grams of the 4 dpf Modified Polyamide fiber specimen were subjected to the compression under a 1-kg. weight as shown in FIGS. 6 [A and B]. The polyamide control was an unmodified nylon-6,6. The modified polyamide contained about 3.5 wt. % modified polyolefin (VA-1840). The same amount of fiber, under the same amount of force showed a difference in compressibility (softness) based on the modification disclosed herein. FIG. 6[A] shows 5 grams of Polyamide Control fiber specimen being compressed under a 1-kg. weight. FIG. 6[B] shows 5 grams of the Modified Polyamide fiber specimen being compressed under a 1-kg. weight.

The two fiber specimens were compressed within a volumetric syringe to allow for visual indication of the extent of compression under the same load of 1 kg. The 4 dpf modified polyamide fiber specimen disclosed herein showed increased compression as compared to that of the 4 dpf control polyamide fiber specimen. The degree of compression may be influenced by the degree of modification and dpf of the polyamide fiber.

### EXAMPLES 11(a-y)

### BCF Yarn Carpet Specimens from Nylon-6 (N6)

As represented in Table 6 below, several Control N6 and modified N6 specimens were prepared for different carpet type constructions, DPFs and by varying the addition level. The polyamide control was an unmodified nylon-6. The modified polyamide contained varying additives and tested levels in nylon-6 as described in Table 6. In Table 6, the term “Addition Level” means the amount of modified polyolefin added to the nylon-6. The specimens with zero addition levels represent Control specimens, specifically, 11(a), 11(e), 11(j), 11(n) and 11(r). None of the Table 6 specimens were post-treated with surface topical treatments.

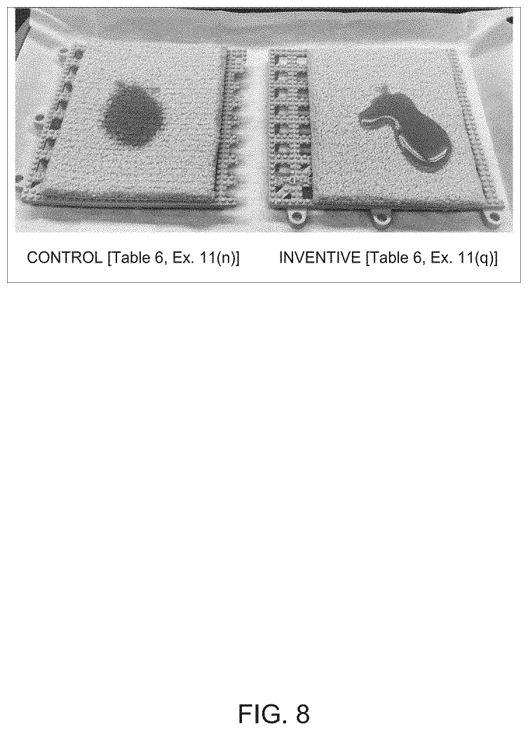

TABLE 6

| | | | | | Aqueous Liquid |
|---|---|---|---|---|---|
| Ex. No. | Carpet Type | DPF | Additive Trade Name | Addition Level, wt. % | Repellency [ALR]Rating |
| 11(a) | Cut Pile | 4 | — | 0.0 [Control] | 0 |
| 11(b) | Construction | | VA1840 | 1.0 | 3 |
| 11(c) | [45 Oz. Face | | | 3.5 | 3 |
| 11(d) | Weight] | | | 7.0 | 3 |
| 11(e) | Trilobal fiber | 8.7 | — | 0.0 [Control] | 0 |
| 11(f) | cross-section | | VA1840 | 1.0 | 3 |
| 11(g) | | | | 3.5 | 3 |
| 11(h) | | | | 7.0 [see FIG. 7] | 3 |
| 11(i) | | | PO1015 | 9.0 | 3 |
| 11(j) | | 18 | — | 0.0 [Control] | Fail |
| 11(k) | | | VA1840 | 1.0 | |
| 11(l) | | | | 3.5 | |
| 11(m) | | | | 7.0 | |
| 11(n) | Loop Pile | 8.7 | — | 0.0 [Control] | Fail |
| 11(o) | Construction | | VA1840 | 1.0 | 3 |
| 11(p) | [18 Oz. Face | | | 3.5 | 3 |
| 11(q) | Weight] | | | 7.0 [see FIG. 8] | 3 |
| 11(r) | Trilobal fiber | 18 | — | 0.0 [Control] | Fail |
| 11(s) | cross-section | | VA1840 | 1.0 | |
| 11(t) | | | | 3.5 | |
| 11(u) | | | | 7.0 | |
| 11(v) | | | | 10.0 | |
| 11(w) | | | PO1015 | 9.0 | |
| 11(x) | Cut Pile | 8.7 | VA1840 | 5.0 | 3 |
| 11(y) | Construction | | | 6.0 | 3 |

The Table 6 examples may be performed for any suitable fiber cross-section, such as and not limited to, four-hole, round, bi-lobal, quad-lobal, penta-lobal, bicomponent, etc. Further the fiber DPF may be in the 1-30 range. Likewise, there is no limit on the addition level tested other than the operational complexity and cost considerations.

Table 7 below lists non-limiting commercially available modified polyolefins that may be useful according to the present disclosure.

TABLE 7

| | | | Calculated ppm (by wt) reacted Polyamide- | | | | |
|---|---|---|---|---|---|---|---|
| | | | polyolefin copolymer (based on modification level | | | | |
| | | Modification | of functional polyolefin used and additive wt. % | | | | |
| | | Level | used) | | | | |
| | Commercial | (wt. %) in | @ 1 | @ 3 | @ 5 | @ 7 | @ 9 |
| | Manuf./Trade | Polyolefin | wt. % | wt. % | wt. % | wt. % | wt. % |
| Polyolefin | Name | additive | additive | additive | additive | additive | additive |
| Polypropylene | ExxonMobil/ | 0.2-0.5 | 20-50 | 60-150 | 100-250 | 140-350 | 180-450 |
| | Exxelor ™ | | | | | | |
| | VA1840 | | | | | | |
| Very low- | Dow | 0.25-0.5 | 25-50 | 75-150 | 125-250 | 175-350 | 225-450 |
| density | Chemicals/ | | | | | | |
| Polyethylene | Amplify ™ | | | | | | |
| [vLDPE] | GR208 | | | | | | |
| Polypropylene | ExxonMobil/ | 0.25-0.5 | 25-50 | 75-150 | 125-250 | 175-350 | 225-450 |
| | Exxelor ™ | | | | | | |
| | PO1015 | | | | | | |
| Ethylene | ExxonMobil/ | 0.5-1 | 50-100 | 150-300 | 250-500 | 350-700 | 450-900 |
| alpha olefin | Exxelor ™ | | | | | | |
| | VA1202 | | | | | | |
| Ethylene | Dow | 0.5-1 | 50-100 | 150-300 | 250-500 | 350-700 | 450-900 |
| octene | Chemicals/ | | | | | | |
| | Amplify ™ | | | | | | |
| | GR216 | | | | | | |
| Pure Ethylene | ExxonMobil/ | 0.5-1 | 50-100 | 150-300 | 250-500 | 350-700 | 450-900 |
| | Exxelor ™ | | | | | | |
| | VA1803 | | | | | | |
| Polypropylene | Ram-On | <1% | Depends on wt. % modification level in | | | | |
| | Industries/ | | polyolefin additive | | | | |
| | Bondyram ® | | | | | | |
| | 7103 | | | | | | |

In Table 7, the term “Modification Level (wt. %) in Polyolefin” means the functionalized level in the polyolefin tested. For example, in the first row of Table 7, polypropylene with 0.2-0.5 wt. % modification level means it is a modified polyolefin having 0.2-0.5 wt. % grafted maleic anhydride content. Such maleated polypropylene is commercially available, for example, Exxelor™ VA1840 Polymer Resin from ExxonMobil. Also, the total Polyamide-polyolefin values functionality is calculated by multiplying the addition level (wt. %) in the total polyamide matrix with the modification level (wt. %) in the modified polyolefin. So, for a BCF yarn specimen made from 93:7 (wt:wt) nylon-6:modified polyolefin having 0.2 wt. % grafted (e.g.: maleated) modification, the total reacted Polyamide-polyolefin modification functionality in the sample is calculated as (0.07)*(0.002)*10⁶ =140 ppmw. The total reacted Polyamide-polyolefin values in Table 7 are calculated based on the range of modification level in the polyolefins.

Yarn Spinning—Dry pellets of polyamide pellets and modified polyolefin are introduced directly into the throat of an extruder. Of note, the extruder design could comprise a single-screw or twin-screw extruder, and the details below may expand on spinning via a twin-screw extruder. For illustration, in Example 11(h) the pellets are fed in the weight ratio of 93:7 N6:modified polyolefin. The 40-mm diameter twin-screw extruder has length to diameter ratio (L/D) of 35.75 and is fitted with 6-zone electrical heaters. The TSE is integrated with an appropriately sized metering pump and spin pack outfitted with a fiber spinneret having 230 holes. The fiber cross-section is trilobal for example. The temperature profile from Zones 1 through 6 of the TSE (feed throat to delivery end) is maintained at 125° C., 197° C., 229° C., 249° C., 252° C., 266° C. The Product temperature is 266° C. Extrusion temperatures may vary depending on the melting point of the polyamide. The metering pump delivery is about 70 lbs/hr and adjustments may be made to produce BCF yarn of about 1000 total denier for the 115 filament yarn bundle after drawing, bulking and winding.

The extruded fibers drop through a cross-flow quench chamber to solidify into undrawn continuous filament yarn. Quenching is in 10-20° C. air at an air-flow rate of about 100-200 ft/min. The undrawn quenched BCF yarn is drawn between a first godet roll pair and a faster second pair of heated godet rolls, and respective surface speeds of 900-1100 yards/min and 2300-3000 m/min, thus drawing at a ratio of 2.5-2.8. The resulting drawn continuous filament yarn is then introduced to a bulk-texturing jet where it is subjected to turbulent air at a temperature of 180° C.-220° C. and 110-130 psi to convert it into BCF yarn. The bulked BCF yarn exits the jet onto a wire mesh screened or perforated drum that pulls ambient air through the yarn under a vacuum. The BCF yarn is then wound onto cylindrical packages using a standard Winder at about 2000-2800 m/min.

Carpet Construction—The above spun BCF yarn is twisted using standard industry procedures. The twisted BCF yarn undergoes heat-setting in commercial heat-set techniques, for which either saturated steam (e.g. Superba®) or superheated steam-setting processes (e.g. Suessan®, Power-Heat-Set™) are effective. The heat-set or lack of heat-set yarn was tufted into various constructions, such as cut pile or loop pile construction. An example of such representative carpet specimen is 45 oz/yd, ⅛″ gauge, 5.7 tpi [twists per inch] with appropriate latex backing.

### Liquid Spill Absorption Resistance

FIGS. 7[A-C] is a representation of time-evolved liquid spill absorption resistance tested for Example 11(h) in Table 6. In Example 11(h), the yarn was spun, as described above, by using 93:7 (wt:wt) nylon-6:maleated polyolefin pellets. The nylon-6 used in 11(h) was 2.4 RV Ultramid™ B24 NFD 02 Nylon-6 product that is commercially available from BASF. The maleated polyolefin in 11(h) was Exxelor™ VA1840 Polymer Resin that is commercially available from ExxonMobil, which has 0.2-0.5% grafted maleic anhydride content and the MFI value of 8. The liquid spill absorption resistance testing was performed at 25° C. by pouring 10 ml of red-colored aqueous solution (water solution of 0.073 g/ml ^{KoolAid}®) onto the top surface of 4″×4″ carpet specimens, i.e., Control Nylon-6 [Ex. 11(e)] and that of Example 11(h). The poured liquid absorption on the specimen surfaces was visually monitored for up to 60 minutes from the start.

In each of FIGS. 7[A-C], the left-side specimen represents the Control nylon-6 [Ex. 11(e)] carpet and the right-side specimen represents that of Example 11(h). It was observed that the specimen of Example 11(h) showed superior spill absorption resistance at all times tested compared to the control carpet specimen [Ex. 11(e)]. The Control carpet specimen completely absorbed all poured red-colored liquid resulting in red stains on the surface. However, specimen according to the present disclosure and Example 11(h) was observed to retain the red-colored liquid on the surface with excellent resistance to absorption into the specimen for 60 minutes of testing.

The other specimens of Table 6 show similar spill absorption resistance improvements when compared to their corresponding Control specimens. FIG. 8 is a visual representation of spill absorption resistance measured for Example 11(q) specimen in comparison with Example 11(n) Control specimen of Table 6. In Example 11(q), the yarn was spun, as described above, by using 93:7 (wt:wt) nylon-6:maleated polyolefin pellets. The nylon-6 used in 11(q) was 2.4 RV Ultramid™ B24 NFD 02 Nylon-6 product that is commercially available from BASF. The maleated polyolefin in 11(q) was Exxelor™ VA1840 Polymer Resin that is commercially available from ExxonMobil. The maleated polyolefin has 0.2-0.5% grafted maleic anhydride content and the MFI value of 8. The spill absorption resistance testing was performed at 25° C. by pouring 10 ml of dye-colored aqueous solution onto the top surface of 4″×4″ carpet specimens, i.e., Control Nylon-6 [Ex. 11(n)] and that of Example 11(q), and visually monitoring the simulated surface spill.

In FIG. 8, the left-side specimen represents the Control nylon-6 [Ex. 11(n)] carpet and the right-side specimen represents that of Example 11(q). It was observed that the Ex. 11(q) specimen showed superior spill absorption resistance compared to the Ex. 11(n) Control carpet specimen. The FIG. 8 left-side Control carpet specimen completely absorbed all poured dye-colored liquid resulting in a deep surface stain. However, the poured liquid on the Example 11(q) specimen surface remained unabsorbed and could be easily wiped off before staining the surface.

FIGS. 9(A-B) represent the SEM Images for the BCF yarn samples prepared according to the present disclosure. The nylon-6 BCF yarn fibers were prepared on a single-screw extruder for the sample of Example 11(h). The yarn was spun by using 93:7 (wt:wt) nylon-6:maleated polyolefin pellets. The nylon-6 used in 11(h) was 2.4 RV Ultramid™ B24 NFD 02 Nylon-6 product that is commercially available from BASF. The maleated polyolefin in 11(h) was Exxelor™ VA1840 Polymer Resin that is commercially available from ExxonMobil, which has 0.2-0.5% grafted maleic anhydride content and the MFI value of 8. The SEM image in FIG. 9(A) was at 2000× magnification and shows various micro-domains dispersed throughout the nylon-6 matrix. FIG. 9 (B) is a 5000× magnification image further showing dispersion of micro-domains in the nylon-6 matrix.

### Aqueous Repellency Performance [ALR] Testing

An adapted procedure from the AATCC 193-2007 method was used for aqueous liquid repellency (ALR) testing. A series of seven different solutions, with each constituting a ‘level’, are prepared using isopropanol [CAS # 67-63-0] and deionized water [CAS # 7732-18-5]. The compositions of these solutions are listed in Table 8 below.

TABLE 8

| | Solution Composition | | Repellency |
|---|---|---|---|
| Bottle | (wt/wt) | | Rating Upon |
| Number | Isopropanol | D.I Water | Failure |
| 0 | — | 100 | Fail |
| 1 | 2 | 98 | 0 |
| 2 | 5 | 95 | 1 |
| 3 | 10 | 90 | 2 |
| 4 | 20 | 80 | 3 |
| 5 | 30 | 70 | 4 |
| 6 | 40 | 60 | 5 |

Starting with the lowest level, three drops of solution were pipetted onto the carpet surface. If at least two out of the three droplets remained above the carpet surface for 10 seconds, the carpet passed the level. The next level was then evaluated. When the carpet failed a level, the aqueous liquid repellency rating was determined from the number corresponding to the last level passed. A result of “Fail” (indicating failed) represents a carpet surface for which 100% deionized water cannot remain above the surface for at least 10 seconds. A result of 0 represents a carpet surface for which 100% deionized water remains above the surface for at least 10 seconds, but a solution of 98% deionized water and 2% isopropanol cannot remain above the surface for at least 10 seconds. A level of 1 would correspond to a carpet for which a solution of 98% deionized water and 2% isopropyl alcohol remains above the surface for at least 10 seconds while a solution of 95% deionized water and 5% isopropyl alcohol cannot remain above the surface for at least 10 seconds.

ALR testing was performed for several carpet specimens according to the Table 6 preparations, and the results are represented in Table 9 below.

TABLE 9

| | | | Addition | ALR |
|---|---|---|---|---|
| Ex. No. | Carpet Type | DPF | Level, wt. % | Rating |
| 11(e) | Cut Pile | 8.7 | 0.0 [Control] | Fail |
| 11(h) | Cut Pile | 8.7 | 7.0 | 3 |
| 11(x) | Cut Pile | 8.7 | 5.0 | 3 |
| 11(y) | Cut Pile | 8.7 | 6.0 | 3 |

It was consistently observed that the specimens according to the present disclosure performed better than their control in the ALR performance testing.

Changing carpet construction parameters within the practical bounds such as pile height, face weight, twist per inch, stitch per inch or type of heatsetting method may impact the repellency behavior of the resulting carpet samples.

### Moisture Absorption Testing

The carpet specimens prepared according to the present disclosure were tested for moisture absorption. Moisture analysis was performed using Mettler-Toledo Halogen Moisture Analyzer Type HR83. The Mettler HR83P/HX-204 halogen moisture analyzer uses a thermo gravimetric method to determine the moisture content of a sample. The samples were conditioned at 50-60% relative humidity at 25° C. for 24 hours. About 10 g of the sample was weighed and cut into 1″ pieces. The samples were then heated at 150° C. to allow the moisture to vaporize. During this process the weight loss was monitored until it no longer changed and the % moisture/solids were calculated. In Table 10-A below, the averaged dry time data represents the specimen dry time measured for each tested sample in triplicate. The tested carpet samples contained 10 g of fiber.

TABLE 10-A

| Ex. | Carpet | Fiber | | Addition | Dry Time at Drying |
|---|---|---|---|---|---|
| No. | Type | Type | DPF | Level, wt. % | Temp of 150° C. |
| 11(q) | Loop | N6 | 8.7 | 7% | 33.45 min |
| — | Loop | N6 | 15 | 0.0 | 38.65 min |

In a second set of experiments, Nylon-6,6 carpet samples were made with 45 oz, 8 DPF and were cut into 2 inch circular pieces. The modified Nylon-6,6 samples were made with 3.5 wt. % VA1840, and the control samples did not have the additive. The carpet samples were exposed to running tap water until saturated, and then dried at 45° C. Moisture analysis was performed using Mettler-Toledo Halogen Moisture Analyzer Type HR83 to measure the drying rate of the samples. Results are shown in Table 10-B below.

TABLE 10-B

| | | | | | | | Dry |
|---|---|---|---|---|---|---|---|
| | | | | | | weight | time |
| | | Dry | Dry | | | (g) | (min)/ |
| Sample | Drying | Time | Time | Wet | Dry | water | gram |
| ID | Temp | (min) | (hr) | Weight | Weight | removed | H2O |
| N6,6 | 45° C. | 457.06 | 7.62 | 14.34 | 2.45 | 11.90 | 38.42 |
| Control | | | | | | | |
| N6,6 | 45° C. | 309.48 | 5.16 | 10.20 | 2.43 | 7.77 | 39.85 |
| Control | | | | | | | |
| N6,6 | 45° C. | 480 | 8.00 | 14.48 | 2.95 | 11.53 | 41.62 |
| Control | | | | | | | |
| | | | | | | Average | 39.96 |
| Modified | 45° C. | 439.43 | 7.32 | 14.63 | 2.47 | 12.16 | 36.13 |
| Nylon-6,6 | | | | | | | |
| Modified | 45° C. | 312.47 | 5.21 | 11.06 | 2.55 | 8.52 | 36.69 |
| Nylon-6,6 | | | | | | | |
| Modified | 45° C. | 464.39 | 7.74 | 13.48 | 2.32 | 11.16 | 41.61 |
| Nylon-6,6 | | | | | | | |
| | | | | | | Average | 38.15 |

It was observed that the modified Nylon-6,6 samples dried at a faster rate than the control samples.

### EXAMPLES 12 (a-d)

### Odor Testing

In these examples, odor testing was performed using four representative specimens as listed in Table 11 below. A rating of 1 indicates that no odor was experienced and a rating of 5 indicatess a very strong (unpleasant) odor.

TABLE 11

| | | | | | Average Odor | |
|---|---|---|---|---|---|---|
| | | | | | Rating* (n = 10) | |
| | Carpet | | | Addition | Immediately | Capped |
| Ex. | Specimen | Carpet | | Level, | and prior to | samples |
| No. | Description | Type | DPF | wt. % | capping | for 6 h |
| 12(a) | N6 [Ex. 11(h)] | Cut | 8.7 | 7.0 | No odor | 1.1 |
| | | pile | | | | |
| 12(b) | N6,6 [Ex. 2(f) | Cut | 8.7 | 7.0 | No odor | 1.0 |
| | eq.] | pile | | | | |
| 12(c) | INVISTA N6,6 | Cut | 8.7 | 0 | Slight odor | 3.1 |
| | residential | pile | | | | |
| | carpet sample | | | | | |
| 12(d) | 3^{rd} Party | Cut | N/A | N/A | Strong odor | 4.4 |
| | Polyester | Pile | | | | |
| | residential | | | | | |
| | carpet sample | | | | | |

The procedure followed is as follows: carpet samples (˜3″ dia. rounds) were prepared and placed in individual petri dishes with a snug fit. A test odor-causing solution was prepared by mixing 40 cc cold water, 20 cc red wine and 20 cc while vinegar. About one full pipette bulb (˜5cc) of the test solution was applied in the middle of the samples. The solution was allowed to soak in the samples for approx. 5 minutes. Each solution-soaked sample surface was then gently blotted using a clean paper towel. These samples were capped and allowed to sit for about 6 hours.

For odor rating tests, the average odor rating score was developed based on ten human testers smelling each sample. The score of between 1 (no odor) and 5 (strong odor) was given for each smell attempt by sample. Between each sample, the testers “cleansed the pallet” by smelling a coffee odor to prevent cross-odor contamination.

As represented in Table 11, this simple odor testing rank clearly showed a remarkable performance for Samples 12(a) and 12(b) compared to Samples 12(c) and 12(d). A very low odor rank for 12(a) and 12(b) means little or no solution absorbed in the sample further demonstrating and confirming superior resistance to liquid spill absorption

### EXAMPLES 13 (a-f)

### Knitted Article [N6 and N6,6]

Table 12 below represents repellency behavior on knitted articles made using N6 and N6,6 fibers. Two yarn DPF variations, i.e., 8.7 and 18 DPF yarns, were used. Yarn modification functionality is calculated per Table 7 ranges. Table 8 provides ALR Ratings detail.

TABLE 12

| | | | | | Calculated ppm | |
|---|---|---|---|---|---|---|
| | | | | | (by wt) reacted | |
| | | | | Addition | Polyamide- | |
| Ex. | Article | | Additive | Level, | polyolefin | ALR |
| No. | Type | DPF | in Fiber | wt. % | copolymer | Rating |
| 13(a) | Knit | 8.7 | — | 0 | — | Fail |
| | [N6] | | | [Control] | | |
| 13(b) | | 8.7 | VA1840 | 7.0 | 140-350 | 3 |
| 13(c) | | 8.7 | PO1015 | 9.0 | 225-450 | 3 |
| 13(d) | | 18 | VA1840 | 7.0 | 140-350 | Fail |
| 13(e) | Knit | 8.7 | — | 0 | — | Fail |
| | [N6,6] | | | [Control] | | |
| 13(f) | | 8.7 | VA1840 | 3.5 | 70-180 | 1 |

It was observed that the 8.7 DPF knits [Ex. 13b, 13c, 13f] showed good repellency compared to the Control [Ex. 13a, 13e] with no additive. The 18 DPF knit article [Ex. 13d], however, failed in the repellency test even with an additive present. None of the samples contained any topical treatments.

### EXAMPLES 14 (a-e)

### Nylon-5,6 Monofilament Fibers [SEM Data]

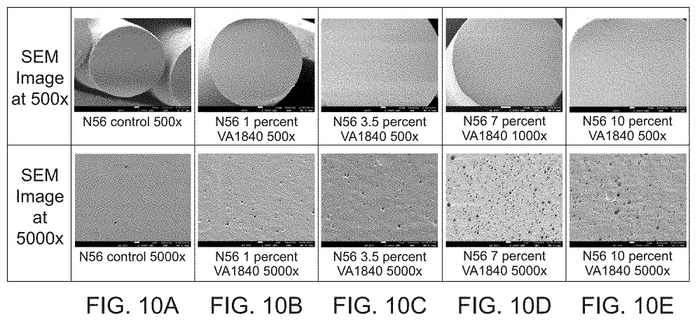

Round, solid cross-section shaped Monofilament fibers of Nylon-5,6 were prepared containing various levels of the additive VA1840 [0.2-0.5 wt. % maleation level] in the 1-10% range using the DSM Xplore 15cc microcompounding extruder. The modified polyolefin additive VA1840 that was used is described in Table 7. Nylon-5,6 used was a commercially available material from Cathay Industrial Biotech Ltd. The SEM images of these monofilament cross-sections at 5000× magnification are shown in FIG. 10. The presence of and increasing levels of micro-domains were clearly visible when the additive level in nylon-5,6 was increased from 1% to 10% (as summarized in table 13 below).

TABLE 13

| | | Calculated ppm (by wt) |
|---|---|---|
| Ex. | Addition Level, | reacted Polyamide- |
| No. | wt. % | polyolefin copolymer |
| 14(a) | 0 [Control] | — |
| 14(b) | 1.0 | 20-50 |
| 14(c) | 3.5 | 70-180 |
| 14(d) | 7.0 | 140-350 |
| 14(e) | 10.0 | 200-500 |

### EXAMPLES 15 (a-p)

### Cut-Pile Carpet Specimens [Nylon-6,6]

In these examples of Table 14 below, several cut-pile carpet specimens were prepared using modified Nylon-6,6 fibers having additive levels in the range up to 7 wt. %. The modified polyolefin additive VA1840 [Table 7] was used in each case. The domain sizes present inside the fiber construction were determined from the SEM analysis of modified fiber cross-sections.

The aqueous liquid repellency [ALR] behavior for the cut-pile carpet specimens made with modified fibers having above 12 DPF was not observed. This aqueous liquid repellency behavior, i.e., water beading on the carpet surface for >10 seconds, was not present for Examples 15(e) through 15(p) in the additive levels tested. The ALR Rating was labeled “Fail” for these specimens. The measured ALR ratings are given for cut-pile carpet specimens made with <12 DPF modified fibers [Examples 15(b) through 15(d)]. “NM” indicates that the domain size was not measured.

TABLE 14

| | | | | Calculated | | |
|---|---|---|---|---|---|---|
| | | | | ppm | | |
| | | | | (by wt) | | |
| | | | | reacted | Domain | |
| | | | Addition | Polyamide- | Size | |
| | | Fiber | Level, | polyolefin | Range | ALR |
| Ex. No. | Carpet Type | DPF | wt. % | copolymer | (μm) | Rating |
| 15(a) | Cut Pile | 8.7 | 0.0 | — | — | 0 |
| | Construction | | [Control] | | | |
| 15(b) | [45 Oz. | | 1.5 | 30-77 | NM | 2 |
| 15(c) | Face Weight] | | 3.5 | 70-180 | 8-200 | 3 |
| 15(d) | Four-hole | | 7.0 | 140-360 | NM | 3 |
| | Hollowfill | | | | | |
| | fiber | | | | | |
| | cross-section | | | | | |
| 15(e) | Cut Pile | 12 | 0.0 | — | — | Fail |
| | Construction | | [Control] | | | |
| 15(f) | [32 Oz. | | 3.5 | 70-180 | 9.3- | |
| | Face Weight] | | | | 255.3 | |
| 15(g) | Trilobal fiber | | 4.5 | 90-230 | NM | |
| 15(h) | cross-section | | 5.5 | 110-280 | 9.3- | |
| | | | | | 276.0 | |
| 15(i) | | 15.4 | 3.5 | 70-180 | 9.3- | Fail |
| | | | | | 205.8 | |
| 15(j) | | | 5.5 | 110-280 | 9.3- | |
| | | | | | 259.8 | |
| 15(k) | | 16.6 | 3.5 | 70-180 | 9.3- | Fail |
| | | | | | 253.9 | |
| 15(l) | | | 5.5 | 110-280 | 9.3- | |
| | | | | | 178.6 | |
| 15(m) | | 17.5 | 0.0 | — | — | Fail |
| | | | [Control] | | | |
| 15(n) | | | 3.5 | 70-180 | 9.3- | |
| | | | | | 219.0 | |
| 15(o) | | | 4.5 | 90-230 | NM | |
| 15(p) | | | 5.5 | 110-280 | NM | |

### EXAMPLES 16 (a-d)

### Cut-Pile Carpet Specimens Nylon-6,61 with and without Topicals

In these examples of Table 15 below, cut-pile carpet specimens were prepared using modified Nylon-6,6 fibers having additive level of 3.5 wt. %. Two trilobal cross-sectioned fiber DPFs were tested. The modified polyolefin additive VA1840 [Table 7] was used in each case. The Fl-Free chemistry is described in paras. [0078]-[0081] of International Publication No. WO 2017/205374 (describing the preparation of concentrates of 74.5% water, 22.6% Laponite® S-S482 (a layered silicate modified with a dispersing agent), 1.7% Dow Corning ® SM 8715 EX (epoxy-modified siloxane emulsion), 1.0% surfactant, and 0.2% biocide.

TABLE 15

| Ex. | | Additive | Addition | Topical | ALR |
|---|---|---|---|---|---|
| No. | DPF | in Fiber | Level, wt. % | Treatment applied | Rating |
| 11(e) | 8.7 | — | 0 [Control] | — | 0 |
| 16(a) | 8.7 | VA1840 | 3.5 | — | 3 |
| 16(b) | | | | 1.5% Fl-Free | 3 |
| | | | | chemistry* | |
| 16(c) | 17.5 | | | — | Fail |
| 16(d) | | | | 1.5% Fl-Free | 3 |
| | | | | chemistry* | |

The carpet specimens of Example 16(a) and 16(c) did not have any topical treatment, while those of Examples 16(b) and 16(d) contained 1.5% on-weight of fiber (owf) fluorine-free topical treatment as described in WO2017/205374A1. In Example 16(a) and 16(b), it was noted that the modified polyamide according to this disclosure, was able to demonstrate comparable ALR performance, even in the absence of a topical treatment. In the case of carpet specimens with fiber dpf greater than 12 (Example 16(c) and 16(d), It was observed that the ALR Rating improved when the topical treatment was applied.

### EXAMPLES 17 (a-e)

### Repellency Performance testing after Hot Water Extraction [HWE]

Several white-dyeable carpet specimens according to the present disclosure were tested for repellency and wicking before and after subjecting to hot-water extraction [HWE] in the absence of surfactants. The cut-pile carpet specimens were prepared using modified Nylon-6,6 fibers having 8.7 dpf, trilobal cross-section and additive level of 3.5 wt. %. The modified polyolefin additive VA1840 [as in Table 7] was used in each case. None of the samples included any topical treatment. The control carpet specimens did not contain any additive.

A commercial hot-water extraction service [Stanley Steamer®] was employed. Both non-HWE and HWE specimens were tested for repellency according to the test method described in Aqueous Repellency Performance [ALR] Testing section and Table 8.

TABLE 16

| | | Repellency Test Performance | | | Observed |
|---|---|---|---|---|---|
| | Additive | [ALR Rating] | | | wicking |
| Ex. | Level | Before HWE | After HWE | | after HWE |
| No. | Wt. % | ALR | # passes | ALR | Treatment |
| 17(a) | 0 | Fail | Up to | Fail | Yes |
| | [Control] | | three | | |
| 17(b) | 3.5% | 1 | One | 1 | No |
| 17(c) | | 1 | Three | 1 | |
| 17(d) | | 2 | One | 3 | |
| 17(e) | | 2 | Three | 2 | |

In Table 16, one pass of HWE indicates one backward and forward motion of the commercial steamer wand over the carpet specimen.

### EXAMPLE 18

### Repellency Testing—Kruss K100 Force Tensiometer

Carpet fiber samples made with varying loadings of the VA1840 additive (1-7wt. %) and carpet fiber dpf (4-18) were mounted on a clip (SH0601 sample holder). Deionized water was placed in a plastic vessel in the sample well. The clip containing the fiber sample was loaded onto the Kruss balance system. The sample well was advanced closely to the fiber sample. The advancing contact angle measurement module in the Kruss K100 was used to measure the force on the wetted fiber. This module involved two sections—(a) advancing the fiber into the liquid solution by 5 mm/min for 1 min and (b) retreating the fiber from the liquid solution by 5 mm/min for 1 min. The force on the wetted fiber (in mN) by the water solution was measured throughout this process. The contact angle calculation portion of the module was not utilized for the hydrophobicity analysis. A positive force indicates water adsorption by the fiber, and a negative force indicates water repelling from the fiber, as shown in Table 17.

TABLE 17

| | | | Measured Force [mN] | |
|---|---|---|---|---|
| | N6 Fiber | | on fiber from Kruss | |
| | DPF | Additive | K100 Force Tensiometer | |
| Ex. | [modified | [VA1840] | @ 30 sec | @ 60 sec |
| No. | polyamide] | Level wt. % | (average) | (average) |
| 18(a) | 4 | 1.0 | −0.23765 | −0.25588 |
| 18(b) | | 3.5 | −0.17542 | −0.29919 |
| 18(c) | | 7.0 | −0.29477 | −0.40113 |
| 18(d) | 8 | 1.0 | −0.21766 | −0.22756 |
| 18(e) | | 3.5 | −0.02057 | −0.11225 |
| 18(f) | | 7.0 | −0.22041 | −0.30387 |
| 18(g) | 18 | 7.0 | 0.365311 | 0.340942 |

As seen in Table 17, the modified polyamide samples showed a decreasing force through the measurement(0-60 s), and especially so in the 30-60 s window. A line of best fit showed a predominantly negative slope for the hydrophobic modified polyamide samples, while the comparative line slope for control samples was either 0 or positive throughout the 0-60 s region. These results further support the hydrophobicity of the modified polyamide carpet fiber.

Examples 18(a)-(c) and Examples 18(d)-(f) were for 4 DPF and 8 DPF carpet fiber specimens, respectively, and having between 1 wt. % and 7 wt. % additive loading. A water repellent behavior was measured for all these specimens. In comparison, Example 18(g) corresponding to the 18 DPF carpet fiber specimen showed positive slopes at both, 30 sec and 60 sec, even at the high additive loading of 7 wt. %, further indicating absence of water repellency above 12 DPF fiber specimens.

A control N6,6 carpet fiber sample [8 DPF, 0 wt % additive] was run using this method, and a positive force of 0.32 mN (at 30 sec) and 0.30 mN (at 60 sec) was observed. The control specimen exhibited no water repellency.

### EXAMPLE 19

### Steam Heatset Shrinkage

The yarns were cable-twisted at 1.8 turns per cm (4.5 turns per inch) and subsequently continuously heat-set on a Superba® machine. The steam heatset shrinkage was measured in the

Examples using the preferred nylon-6 heatsetting conditions: autoclave tunnel temperatures of about 124° C., residence time of about 35 seconds, belt mass of about 225 grams per meter, and circulating blower system tunnel fan at about 1000 rpm. For N6,6, the autoclave temperature was 129.6° C.

In order to measure the denier of the twisted yarn, a 10 g weight load was applied at the end of 2 m of the twisted fiber to ensure uniform length. The weight of the twisted yarn for 2 m of fiber was divided by 4 (to account for 2-ply, as well as to adjust for weight of 1 m), and then multiplied by 9000.

The Shrinkage was calculated from the difference in linear density (e.g., denier) before and after steam heatsetting. The calculation was based on the following formula in Which “H_{b}” was the BCF yarn denier before heatsetting, and “Hₐ” was the BCF yarn denier after steam heatsetting. % Steam Heatset Shrinkage=100*[(Hₐ−H_{b})/H_{b}]. The calculated steam heatset shrinkage values are tabulated in Table 18 below.

TABLE 18

| | | | | % Steam |
|---|---|---|---|---|
| | Fiber | | Additive | Heatset |
| Ex. No | Type | DPF | Level, wt. % | Shrinkage |
| 19(a) | N6 | 8.7 | 0 [Control] | 27.87 |
| 19(b) | | | 1.0 | 23.54 |
| 19(c) | | | 3.5 | 29.75 |
| 19(d) | | | 7.0 | 32.02 |
| 19(e) | N6, 6 | 8.7 | 0 [Control] | 9.77 |
| 19(f) | | | 1.5 | 14.81 |
| 19(g) | | | 2.5 | 12.70 |
| 19(h) | | | 3.5 | 16.20 |

### EXAMPLE 20

### Boil Off Water Shrinkage

Yarns were conditioned at uniform environmental conditions for 24 hours prior to the testing. About 160-170 cm of each yarn was tied in to a loop approximately 80-85 cm. A 10g weight was attached to the yarn to ensure uniformity in length measurements. The length of each yarn was measured prior to the boil-off water shrinkage test (labeled “L_{b}”). The yarn samples were then added to boiling water (2 quarts) for 3 min. The samples were removed, rinsed with cold water, patted dry using paper towels, and left to hang dry (without weight) overnight for 12 hours. The length of the samples was measured after drying (labeled “Lₐ”). % Boil-off Water Shrinkage=100*[(L_{b}−Lₐ)/L_{b}]. The calculated boil-off water shrinkage values are tabulated in Table 19 below.

TABLE 19

| Ex. | Fiber | | Additive | % Boil Water |
|---|---|---|---|---|
| No. | Type | DPF | Level, wt. % | Shrinkage |
| 20(a) | N6 | 8.7 | 1.0 | 9.64 |
| 20(b) | | | 3.5 | 11.01 |
| 20(c) | | | 7.0 | 10.95 |
| 20(d) | | 18 | 0 [Control] | 10.23 |
| 20(e) | | | 1.0 | 11.04 |
| 20(f) | | | 3.5 | 11.20 |
| 20(g) | | | 7.0 | 10.78 |
| 20(h) | | | 10.0 | 11.88 |
| 20(i) | N6, 6 | 7.35 | 0 [Control] | 11.78 |
| 20(j) | | 7.35 | 2.5 | 10.33 |

As shown in Table 19, the calculated percentage boil water shrinkage was not significantly different for the modified samples as compared to the control examples. This result was surprising and unexpected.

In Table 20 below, the unexpected and surprising technical improvements according to the present disclosure over unmodified polyamide [UMPA] control specimens are summarized for the prepared modified polyamide [MPA] compositions, prepared fibers/yarns from these MPA compositions, and carpet/knitted fabric specimens obtained from these fibers/yarns.

TABLE 20

| | Modified Polyamide (MPA) Specimens tested Versus Unmodified Polyamide (UMPA) | | | |
|---|---|---|---|---|
| | Specimens | | | |
| | MPA Composition | | | |
| Observed | containing | Fiber made | | |
| Technical | modified | from MPA | Carpet made | |
| Effect | polyolefin | compositions | from fiber/yarn | Supporting Data |
| DSC-Enthalpy | Lower-indicates | | | Example 1, FIG. 1 |
| of Fusion | additive is at least | | | |
| | partially reacted in | | | |
| | the PA matrix | | | |
| Gelling | reduced-more | | | Example 8, Tables 4A-B |
| | modified olefin, | | | |
| | longer the gel time | | | |
| Tendency to | reduced [TSE | | | Example 8 |
| stick to metal | experience] | | | |
| surfaces | | | | |
| Structural | | Micro-domains in | | N6, 6-Ex. 4, FIG. 2 |
| | | C.S view; micro- | | N6-FIG. 9 |
| | | cylinders in | | N5, 6-Ex. 14, Table 13 |
| | | longitudinal cut | | |
| | | view | | |
| Mechanical | | Reduced tenacity; | | Ex. 9, FIG. 5, Table 5 |
| Properties | | higher elongation | | |
| | | at break; higher | | |
| | | tensile strain at | | |
| | | break | | |
| Wicking | | Suppressed | | Example 5, FIG. 3 |
| Compressibility/ | | Improved | Softer | Fibers-Ex. 10, FIG. 6 |
| Softness | | compressibility | | Carpet-Ex. 2, Table 1 |
| Steam Heatset | | >20% for N6 | | N6 and N6, 6-Ex. 19, |
| Shrinkage | | <20% for N6, 6 | | Table 18 |
| Boil-off Water | | No significant | | N6 and N6, 6-Ex. 20, |
| Shrinkage | | change | | Table 19 |
| [BWS] | | | | |
| Aqueous liquid | | | Improved | N6-Ex. 11, Tables 6 and |
| Repellency | | | | 9, FIG. 7-8; |
| [ALR] | | | | N6, 6-Ex. 15-16, Tables |
| | | | | 14-15; |
| | | | | N6 and N6, 6 knitted |
| | | | | fabrics-Ex. 13 Table 12 |
| Liquid | | | Improved | Example 17, Table 16 |
| repellency | | | | |
| preservation | | | | |
| upon HWE | | | | |
| Liquid (spill) | | | Suppressed | FIGs. 7 and 8 |
| absorption on | | | | |
| surface | | | | |
| Moisture | | | Reduced | Table 10 |
| Absorption | | | | |
| Drying Rate | | | Faster | |
| | | | Reduced; | |
| Staining | | | Suppressed | Example 6, FIG. 4 |
| | | | penetration into | |
| | | | the carpet | |
| Odor | | | Improved | Example 12, Table 11 |
| Resistance | | | | |
| Durability | | | Marginally | Example 3, Table 2 |
| [Vetterman | | | improved | |
| Drum Test | | | | |
| 5 K/10 K/15 K | | | | |
| cycles] | | | | |
| Flammability | | | Similar and no | Example 7, Table 3 |
| | | | performance | |
| | | | degradation | |

### EMBODIMENTS

The following embodiments are contemplated. All combinations of features and embodiment are contemplated.

Embodiment 1: A fiber comprising: a first continuous polymer phase; and a second polymer phase at least partially immiscible with the first continuous polymer phase and distributed in the first continuous polymer phase; wherein the second polymer phase comprises a modified polyolefin copolymer having a Melt Flow Index as measured by ASTM D1238 (190° C./2.16 kg) from 0.25 g/10 min to 20.0 g/10 min, and wherein an article made from the fiber has an ALR rating from 0 to 3 in the absence of any additional externally applied treatment to enhance the ALR rating.

Embodiment 2: The fiber of embodiment 1, wherein the first continuous polymer phase comprises at least one of a polyamide, a polyester, and combinations thereof.

Embodiment 3: The fiber of any one of embodiments 1-2, wherein the polyamide is the reaction product of an aliphatic diacid and an aliphatic diamine.

Embodiment 4: The fiber of any one of the preceding embodiments, wherein the polyamide comprises nylon-6, nylon-6,6, nylon-5,6, an aromatic polyamide, a partially aromatic polyamide, and combinations thereof

Embodiment 5: The fiber of any one of the preceding embodiments, wherein the modified polyolefin copolymer is maleated.

Embodiment 6: The fiber of any one of the preceding embodiments, wherein the maleated polyolefin copolymer has a degree of maleation from 0.05 to 1.5 wt. % of the polyolefin copolymer, preferably from 0.1 to 1.4 wt. %, more preferably from 0.15 to 1.25 wt. %.

Embodiment 7: The fiber of any one of the preceding embodiments, wherein the polyolefin copolymer is selected from the group consisting of polyolefin, polyacrylate, and combinations thereof.

Embodiment 8: The fiber of any one of the preceding embodiments, wherein the polyolefin copolymer is an ionomer.

Embodiment 9: The fiber of any one of the preceding embodiments, wherein the polyolefin copolymer has a core-shell structure.

Embodiment 10: The fiber of any one of embodiments 2-9, wherein a) the polyamide comprises nylon-6, and the polyolefin copolymer is present at from 0.1 wt. % to 10 wt. %, preferably from 0.2 to 9 wt. %, more preferably from 0.25 to 8.5 wt. %; or b) the polyamide comprises nylon-6,6, and the polyolefin copolymer is present at from 0.1 wt. % to 7 wt. %, preferably from 0.25 to 6.5 wt. %, more preferably from 0.3 to 6 wt. %.

Embodiment 11: The fiber of any one of the preceding embodiments, wherein the hydrophobicity as measured by water contact angle is from 95° to 120°, preferably from 100° to 115°, or as measured by force by a Kruss K100 Force Tensiometer is negative when a tested fiber is immersed into deionized water in accordance with the test method disclosed herein.

Embodiment 12: The fiber of any one of the preceding embodiments, wherein the modified polyolefin copolymer has a Melt Flow Index as measured by ASTM D1238 (190° C./2.16 kg) from 0.5 to 15.0 g/10 min, preferably from 1.0 to 12.0 g/10 min.

Embodiment 13: The fiber of any one of the preceding embodiments, wherein the second polymer phase is distributed in the first continuous polymer phase in domains as measured by Scanning Electron Microscopy ranging from 5 to 500 nm in cross sectional diameter, preferably from 9 to 400 nm, and from 50 nm to 6000 nm in longitudinal length, preferably from 100 to 5000 nm.

Embodiment 14: The fiber of any one of embodiments 2-12, wherein the fiber comprises from 0.1 to 10 weight % of the modified polyolefin copolymer, preferably from 0.2 to 9 wt. %, more preferably from 0.25 to 8.5 wt. %. of which up to 8 wt. % includes at least one polar functional group; and from 90 to 99.9 weight % of the polyamide.

Embodiment 15: The fiber of any one of the preceding embodiments, wherein the fiber has a dpf of 40 or less, preferably 35 or less, more preferably 30 or less.

Embodiment 16: The fiber of any one of the preceding embodiments, wherein the modified polyolefin copolymer is a reaction product formed in the presence of the first continuous polymer phase.

Embodiment 17: The fiber of any one of the preceding embodiments, wherein the flame resistance performance is not decreased compared to a fiber consisting of the first continuous polymer phase in the absence of the second polymer phase.

Embodiment 18: The fiber of any one of embodiments 1-17, wherein the second polymer phase is discontinuous.

Embodiment 19: The fiber of any one of embodiments 1-17, wherein the second polymer phase is continuous.

Embodiment 20: The fiber of claim 19 wherein the continuous second polymer phase is present as an interpenetrating network.

Embodiment 21: A fiber comprising a) a first continuous polymer phase; and b) a second polymer phase at least partially immiscible with the first continuous polymer phase and distributed in the first continuous polymer phase; wherein the fiber comprises from 1 ppm to 300 ppm by weight reacted polyamide-polyolefin copolymer, based on the total weight of fiber, and wherein an article made from the fiber has an ALR rating of at least 0 in the absence of any additional externally applied treatment to enhance the ALR rating, for example, from ≥0 to ≤3.

Embodiment 22: The fiber of embodiment 21, wherein the fiber comprises from 5 ppm to 250 ppm by weight reacted polyamide-polyolefin copolymer, based on the total weight of the fiber.

Embodiment 23: The fiber of any one of embodiments 21-22, wherein the first continuous polymer phase comprises nylon-6, nylon-6,6, nylon-5,6, a partially aromatic polyamide, an aromatic polyamide, or combinations thereof.

Embodiment 24: The fiber of any one of embodiments 21-23, wherein the second polymer phase comprises a polymer having a Melt Flow Index as measured by ASTM D1238 (190° C./2.16 kg) from 0.25 to 20.0 g/10 min

Embodiment 25: The fiber of any one of embodiments 21-24, wherein the water contact angle is from 90° to 130°, preferably from 95° to 125°.

Embodiment 26: A yarn comprising the fiber of any of the preceding embodiments.

Embodiment 27: A carpet comprising the fiber of any of the preceding embodiments.

Embodiment 28: A composition comprising a first polyamide continuous phase and a second modified polyolefin copolymer discontinuous phase, wherein the combination exhibits reduced polymer-to-metal adhesion when the composition is in the melt or when the composition is in the form of a fiber, as compared to a fiber without the second modified polyolefin copolymer discontinuous phase.

Embodiment 29: The composition of Embodiment 28, wherein the modified polyolefin copolymer is maleated.

Embodiment 30: A method for reducing the gelation rate of a condensation polyamide comprising adding to the condensation polyamide from 0.1 to 10 wt. % of a maleated polyolefin copolymer, wherein the degree of maleation in the polyolefin copolymer is from 0.05 to 1.5.

Embodiment 31: The method of embodiment 30, wherein the condensation polyamide comprises nylon-6,6, nylon-6, nylon-5,6, an aromatic polyamide, or combinations thereof.

Embodiment 32: A hydrophobic carpet comprising a polyamide, and comprising maleated polyolefin copolymer, wherein the carpet ALR value is at least 0, and wherein when the polyamide is nylon-6, the Steam Heatset Shrinkage is greater than 20%.

Embodiment 33: The carpet of embodiment 32, wherein the degree of maleation of the maleated polyolefin copolymer is from 0.1 to 1.5 wt. %, and the polyolefin copolymer is present at from 0.2 wt. % to 9 wt. %, based on the total weight of the carpet.

Embodiment 34: The carpet of any one of embodiments 32-33, wherein the carpet meets at least one of the following conditions as compared to a carpet without the maleated polyolefin: a) equal or improved durability when measured according to the Vetterman 5/10/15K Drum testing ASTM D5417-05, b) improved water repellency preservation after Hot Water Extraction [HWE] conditions, c) suppressed liquid spill absorption on surface, d) reduced drying time, e) suppressed staining and sub-surface stain penetration, f) improved odor resistance, g)equivalent flammability performance, and h) improved softness.

Embodiment 35: The carpet according to embodiment 34, wherein the carpet meets two of the conditions, three of the conditions, four of the conditions, five of the conditions, six of the conditions, seven of the conditions, or eight of the conditions.

Embodiment 36: The fiber of any one of embodiments 31-35, wherein the boil off water shrinkage is unchanged.

Embodiment 37: The fiber of any one of embodiments 31-35, wherein when the polyamide is a polyamide other than nylon-6, the Steam Heatset Shrinkage is less than 20% and boil off water shrinkage is unchanged.

Embodiment 38: A hydrophobic carpet comprising nylon-6,6 and modified polyolefin copolymer, wherein the carpet ALR value is at least 0.

Embodiment 39: The carpet of embodiment 39, wherein the modified polyolefin copolymer is maleated.

Embodiment 40: A hydrophobic carpet comprising nylon-5,6 and modified polyolefin copolymer, wherein the carpet ALR value is at least 0.

Embodiment 41: The carpet of embodiment 40, wherein the modified polyolefin copolymer is maleated.

Embodiment 42: A hydrophobic carpet comprising an aromatic polyamide and modified polyolefin copolymer, wherein the carpet ALR value is at least 0.

Embodiment 43: The carpet of embodiment 40, wherein the modified polyolefin copolymer is maleated.

Embodiment 44: A hydrophobic carpet comprising a partially aromatic polyamide and modified polyolefin copolymer, wherein the carpet ALR value is at least 0.

Embodiment 45: The carpet of embodiment 44, wherein the modified polyolefin copolymer is maleated.

Embodiment 46: Fiber comprising:
(a) a first continuous polymer phase; and
(b) a second polymer phase at least partially immiscible with the first continuous polymer phase and distributed in the first continuous polymer phase;
wherein the second polymer phase comprises a modified polyolefin copolymer having a Melt Flow Index as measured by ASTM D1238 (190° C./2.16 kg) from 0.25 g/10 min to 20.0 g/10 min, and wherein an article made from an article made
from the fiber has at least one property selected from the following;
   i. an ALR rating from 0 to 3 in the absence of any additional externally applied treatment to enhance the ALR rating; or
   ii. Compared to a control without the second polymer:
   iii. lower enthalpy of fusion;
   iv. reduced gel formation during processing;
   v. Lower adhesion to a metal surface of specified properties including surface roughness;
   vi. Reduced tenacity;
   vii. Higher elongation at break;
   viii. Higher tensile strain at break;
   ix. Improved compressibility;
   x. Enhanced liquid repellency preservation upon HWE as described in Example 17, Table 16, herein;
   xi. Suppressed liquid absorption when formed as a surface;
   xii. Reduced moisture absorption;
   xiii. Faster drying;
   xiv. Reduced staining;
   xv. Improved odor resistance;
   xvi. Improved durability as tested in a Vetterman Drum Test as described here; and
   xvii. Comparable flammability performance.

What is claimed is:

1. Fiber comprising:
a first continuous polymer phase; and
a second polymer phase at least partially immiscible with the first continuous polymer phase and distributed in the first continuous polymer phase;
wherein the second polymer phase comprises a modified polyolefin copolymer having a Melt Flow Index as measured by ASTM D1238 (190° C./2.16 kg) from 0.25 g/10 min to 20.0 g/10 min, and wherein an article made from the fiber has an ALR rating from 0 to 3 in the absence of any additional externally applied treatment to enhance the ALR rating.

2. The fiber of claim 1, wherein the first continuous polymer phase comprises at least one of a polyamide, a polyester, a polyimide, a polyurethane, a polyurea and combinations thereof

3. The fiber of claim 1, wherein the polyamide is the reaction product of an aliphatic diacid and an aliphatic diamine.

4. The fiber of claim 1, wherein the polyamide comprises nylon-6, nylon-6,6, nylon-5,6, a partially aromatic polyamide, an aromatic polyamide, and combinations thereof.

5. The fiber of claim 1, wherein the modified polyolefin copolymer is maleated, epoxidized or acrylated.

6. The fiber of claim 1, wherein the polyolefin copolymer has a degree of maleation from 0.05 to 1.5 wt. % of the polyolefin copolymer, preferably from 0.1 to 1.4 wt. %, more preferably from 0.15 to 1.25 wt. %.

7. The fiber of claim 1, wherein the polyolefin copolymer is selected from the group consisting of polyolefin, polyacrylate, and combinations thereof.

8. The fiber of claim 1, wherein the polyolefin copolymer is an ionomer.

9. The fiber of claim 1, wherein the polyolefin copolymer has a core-shell structure.

10. The fiber of claim 2, wherein:
a. The polyamide comprises nylon-6, and the polyolefin copolymer is present at from

0. 1 wt. % to 10 wt. %, preferably from 0.2 to 9 wt. %, more preferably from 0.25 to 8.5 wt. %; or b. The polyamide comprises nylon-6,6, and the polyolefin copolymer is present at from 0.1 wt. % to 7 wt. %, preferably from 0.25 to 6.5 wt. %, more preferably from 0.3 to 6 wt.%.

11. The fiber of claim 1, wherein the hydrophobicity:
a. as measured by water contact angle is from 90° to 130°, preferably from 95° to 125°, more preferably from 100° to 115°; or
b. as measured by force by a Kruss K100 Force Tensiometer is negative when a tested fiber is immersed into deionized water in accordance with the test method disclosed herein.

12. The fiber of claim 1, wherein the modified polyolefin copolymer has a Melt Flow Index as measured by ASTM D1238 (190° C./2.16 kg) from 0.5 to 15.0 g/10 min, preferably from 1.0 to 12.0 g/10 min.

13. The fiber of claim 1, wherein the second polymer phase is distributed in the first continuous polymer phase in domains as measured by Scanning Electron Microscopy ranging from 5 to 500 nm in cross sectional diameter, preferably from 9 to 400 nm, and from 50 nm to 6000 nm in longitudinal length, preferably from 100 to 5000 nm.

14. The fiber of claim 2, wherein the fiber comprises from 0.1 to 10 weight % of the modified polyolefin copolymer, preferably from 0.2 to 9 wt. %, more preferably from 0.25 to 8.5 wt. %. of which up to 8 wt. % includes at least one polar functional group; and from 90 to 99.9 weight % of the polyamide.

15. The fiber of claim 1, wherein the fiber has a dpf of 40 or less, preferably 35 or less, more preferably 30 or less.

16. The fiber of claim 1, wherein the modified polyolefin copolymer is a reaction product formed in the presence of the first continuous polymer phase.

17. The fiber of claim 1, wherein the flame resistance performance is not decreased compared to a fiber consisting of the first continuous polymer phase in the absence of the second polymer phase.

18. The fiber of claim 1, wherein the second polymer phase is discontinuous.

19. The fiber of claim 1, wherein the second polymer phase is continuous.

20. The fiber of claim 19, wherein the continuous second polymer phase is present as an interpenetrating network.

21. Fiber comprising
a. a first continuous polymer phase; and
b. a second polymer phase at least partially immiscible with the first continuous polymer phase and distributed in the first continuous polymer phase;
wherein the fiber comprises from 1 ppm to 300 ppm by weight reacted polyamide-polyolefin copolymer, based on the total weight of fiber, and wherein an article made from the fiber has an ALR rating of at least 0 in the absence of any additional externally applied treatment to enhance the ALR rating.

22. The fiber according to claim 21, wherein the fiber comprises from 5 ppm to 250 ppm by weight reacted polyamide-polyolefin copolymer, based on the total weight of the fiber.

23. The fiber according to claim 21, wherein the first continuous polymer phase comprises nylon-6, nylon-6,6, nylon-5,6, a partially aromatic polyamide, an aromatic polyamide, or combinations thereof.

24. The fiber according to claim 21, wherein the second polymer phase comprises a polymer having a Melt Flow Index as measured by ASTM D1238 (190° C./2.16kg) from 0.25 to 20.0 g/10 min

25. The fiber of claim 21, wherein the fiber has a water contact angle from 90° to 130°, preferably from 95° to 125°.

26. A yarn comprising the fiber of claim 21.

27. A carpet comprising the fiber of claim 21.

28. A composition comprising a first polyamide continuous phase and a second modified polyolefin copolymer discontinuous phase, wherein the combination exhibits reduced polymer-to-metal adhesion when the composition is in the melt or when the composition is in the form of a fiber as compared to a composition without the second modified polyolefin copolymer discontinuous phase.

29. A method for reducing the gelation rate of a condensation polyamide comprising adding to the condensation polyamide from 0.1 to 10 wt. % of a maleated polyolefin copolymer, wherein the degree of maleation in the polyolefin copolymer is from 0.05 to 1.5 wt. %.

30. The method of claim 29 wherein the condensation polyamide comprises nylon-6,6, nylon-6, nylon-5,6, a partially aromatic polyamide, an aromatic polyamide, or combinations thereof.

31. A hydrophobic carpet comprising a polyamide, and comprising maleated polyolefin copolymer, wherein the carpet ALR value is at least 0, and wherein when the polyamide is nylon-6, the Steam Heatset Shrinkage is greater than 20%.

32. The hydrophobic carpet of claim 31 wherein the dpf is from ≥1 to ≤12.

33. The carpet of claim 31 wherein the degree of maleation of the maleated polyolefin copolymer is from 0.1 to 1.5 wt. %, and the polyolefin copolymer is present at from 0.2 wt. % to 9 wt. %, based on the total weight of the carpet.

34. The carpet of claim 31, wherein the carpet meets at least one of the following conditions as compared to a carpet without the maleated polyolefin:
a. equal or improved durability when measured according to the Vetterman 5/10/15K Drum testing ASTM D5417-05,
b. improved water repellency preservation after Hot Water Extraction [HWE] conditions,
c. suppressed liquid spill absorption on surface,
d. reduced drying time,
e. suppressed staining and sub-surface stain penetration,
f. improved odor resistance,
g. equivalent flammability performance, and/or
h. improved softness.

35. The carpet of claim 31, wherein the boil off water shrinkage is unchanged.

36. The carpet of claim 31, wherein the polyamide is a polyamide other than nylon-6 and wherein the Steam Heatset Shrinkage is less than 20%.

37. Fiber comprising:
a first continuous polymer phase; and
a second polymer phase at least partially immiscible with the first continuous polymer phase and distributed in the first continuous polymer phase;
wherein the second polymer phase comprises a modified polyolefin copolymer having a Melt Flow Index as measured by ASTM D1238 (190° C./2.16 kg) from 0.25 g/10 min to 20.0 g/10 min, and wherein an article made from an article made from the fiber has at least one property selected from the following;
(c) an ALR rating from 0 to 3 in the absence of any additional externally applied treatment to enhance the ALR rating; or
(d) Compared to a control without the second polymer:
(i) lower enthalpy of fusion;
(ii) reduced gel formation during processing;
(iii)Lower adhesion to a metal surface of specified properties including surface roughness;
(iv)Reduced tenacity;
(v) Higher elongation at break;
(vi) Higher tensile strain at break;
(vii) Improved compressibility;
(viii) Enhanced liquid repellency preservation upon HWE as described in Example 17, Table 16, herein;
(ix) Suppressed liquid absorption when formed as a surface;
(x) Reduced moisture absorption;
(xi) Faster drying;
(xii) Reduced staining;
(xiii) Improved odor resistance;
(xiv) Improved durability as tested in a Vetterman Drum Test as described here; and
(xv) Comparable flammability performance.
